(19) United States
(12) Patent Application Publication
(10) Pub. No.: US 2010/0205225 A1
(43) Pub. Date: Aug. 12, 2010

(54) Method and Apparatus for Transforming a Process

(75) Inventors: Steven Ahlig, Kottgeisering (DE); Claude-Rene Clementi, Munchen (DE); Sandra Dieckmann, Munchen (DE); Oliver Hammrich, Forchheim (DE)

Correspondence Address: LERNER GREENBERG STEMER LLP, P O BOX 2480, HOLLYWOOD, FL, 33022-2480, US

(73) Assignee: SIEMENS AKTIEGESELLSCHAFT, Munchen (DE)

(21) Appl. No.: 12/399,646

(22) Filed: Mar. 6, 2009

(30) Foreign Application Priority Data
Feb. 6, 2009 (EP) EP 09001674

(51) Int. Cl. G06F 17/30

(52) U.S. Cl. 707/803; 707/E17.044; 707/E17.014; 707/E17.005

(57) ABSTRACT

A method and an apparatus for transforming generic processes of a domain into executable processes. The method includes the following steps: selecting from a list of generic processes stored in a process repository at least one generic process for a context of the respective domain, performing an operationalization of process elements of said selected processes to generate a corresponding transaction model depending on said context, and instantiating said transaction model on occurrence of a transaction trigger to generate an executable transaction model instance. The method can be implemented as an efficient tool for project planning in an organization comprising several operative units.

### CROSS-REFERENCE TO RELATED APPLICATION

This application claims the priority, under 35 U.S.C. §119, of European patent application EP 09 001 674, filed Feb. 6, 2009; the prior application is herewith incorporated by reference in its entirety.

### BACKGROUND OF THE INVENTION

### Field of the Invention

The invention relates to a method and apparatus for transforming a generic process of a domain into an executable process.

Processes such as technical and business processes despite of their importance are usually implemented as an ad hoc collection of applications, middleware, workflow, manual procedures and user knowledge and, therefore are rather inflexible requiring a high effort in case that the respective process has to be changed or a process has to be created. Processes are mostly performed by operative units within an organization. The objectives of the different operative units can be different. On the other hand, process modelling technologies available can support operative units of an organization such as a company or an enterprise for a group of users working in different operative units. These process modelling technologies can provide a shared environment for the capture, design and simulation of processes. Processes can be displayed in graphical form and can support users in implementing processes in different environments. However, there exists a gap between standardized process models on one side and operational processes provided for daily tasks on the other side.

### SUMMARY OF THE INVENTION

Accordingly, it is an object of the present invention to provide a method and an apparatus to transform generic processes into executable processes for an operative unit.

The invention provides a method for transforming generic processes of a domain into executable processes, said method comprising the steps of:

selecting from a list of generic processes stored in a process repository a generic process for a context of the respective domain;

performing an operationalization of process elements of said selected processes to generate a corresponding transaction model depending on said context; and

instantiating said transaction model on occurrence of a transaction trigger to generate an executable transaction model instance.

In an embodiment of the method according to the present invention, the transaction model instance is executed by a process execution engine.

In an embodiment of the method according to the present invention, the context indicates constraints for an operative unit comprising mandatory context parameters and optional context parameters.

In an embodiment of the method according to the present invention, the context is selected from a predefined context stored in a context repository.

In an embodiment of the method according to the present invention, the transaction model is a business transaction model performing a target process to be implemented.

In an embodiment of the method according to the present invention, a process element comprises attributes which are adapted to operationalize the respective process element.

In an embodiment of the method according to the present invention, a consistency check of the modified process elements is performed.

In an embodiment of the method according to the present invention, the attributes of a process element comprise

inputs, outputs, roles, persons, documentation, mile stones, applications, risks, metrics, services and operative units.

In an embodiment of the method according to the present invention, the context parameters comprise clients, products, services, organizations, locations, complexities of applications and interfaces to other processes.

The invention further provides a tool for transformation of a process comprising a program for performing the following steps:

selecting from a list of generic processes stored in a process repository a generic process for a context of the respective domain;

performing an operationalization of process elements of said selected processes to generate a corresponding transaction model depending on said context; and

instantiating said transaction model on occurrence of a transaction trigger to generate an executable transaction model instance.

In an embodiment of the tool according to the present invention, the transaction model instance generated by said tool is executed by a process execution engine.

In an embodiment of the tool according to the present invention, the tool is formed by a software tool stored on a data carrier.

The invention further provides an apparatus for transformation of a selected process model comprising:

an operationalization unit which performs an operationalization of process elements of the selected process model to generate a transaction model depending on a stored context indicating the constraints of an operative unit; and

an instantiation unit which performs an instantiation of said transaction model on occurrence of a transaction trigger to generate an executable transaction model instance.

In an embodiment of the apparatus according to the present invention, each process element comprises attributes which are adaptable to operationalize the respective process element, the attributes comprising: inputs, outputs, roles, persons, documentation, mile stones, applications, risks, metrics, services and operative units.

In an embodiment of the apparatus according to the present invention, the context is stored in a context repository comprising mandatory and optional context parameters.

In an embodiment of the apparatus according to the present invention, the context parameters comprise clients, products, services, organizations, locations, complexities of applications and interfaces to other processes.

In an embodiment of the apparatus according to the present invention, the transaction model instance is executed by a process execution engine.

The invention further provides an apparatus for transformation of a process comprising:

means for selecting from a list of generic processes stored in a process repository generic processes for a context of a domain;

means for performing an operationalization of process elements of the selected processes to generate a corresponding transaction model depending on the context; and

means for instantiating said transaction model on occurrence of a transaction trigger to generate an executable transaction model instance.

Other features which are considered as characteristic for the invention are set forth in the appended claims.

Although the invention is illustrated and described herein as embodied in a method and an apparatus for transforming a process, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments of the method and apparatus for transformation of generic processes when read in connection with the accompanying drawings.

### BRIEF DESCRIPTION OF THE SEVERAL VIEWS OF THE DRAWING

FIG. 1 shows a diagram illustrating a method and a tool according to the present invention for transforming generic processes;

FIG. 2 shows a flowchart of a possible embodiment of a method for transforming generic processes according to the present invention;

FIG. 3 shows a flowchart indicating an overview of the customizing and execution of a process according to the present invention;

FIG. 4 shows a generic P&I process as an example of a generic process to which the method according to the present invention is applied;

FIG. 5 shows the process as shown in FIG. 4 with a marked-up start function to illustrate a step within the method according to the present invention;

FIG. 6 shows a selection of the start function to illustrate a step of the method according to the present invention;

FIG. 7 shows a start function and possible follow-on functions to illustrate a step of the method according to the present invention;

FIG. 8 shows a highlighting of selected sub-processes during customizing of a process as performed by the method according to the present invention;

FIG. 9 shows an example of customizing a process on a detailed level as performed by the method according to the present invention;

FIG. 10 shows an overview and a detailed display of an exemplary activity “defined target process” to illustrate the method according to the present invention;

FIG. 11 shows an example of a collaboration view as provided by an embodiment of the method according to the present invention;

FIG. 12 shows a detailing of an exemplary activity “define target process” to illustrate a step of a possible embodiment of the method according to the present invention;

FIG. 13 shows an example of a prompted decision on whether an exemplary activity is to be executed as performed in a step of a possible embodiment of the method according to the present invention;

FIG. 14 illustrates relationships between a project plan, a transaction model, a ticket and a task as employed in a possible embodiment of the method according to the present invention.

### DETAILED DESCRIPTION OF THE INVENTION

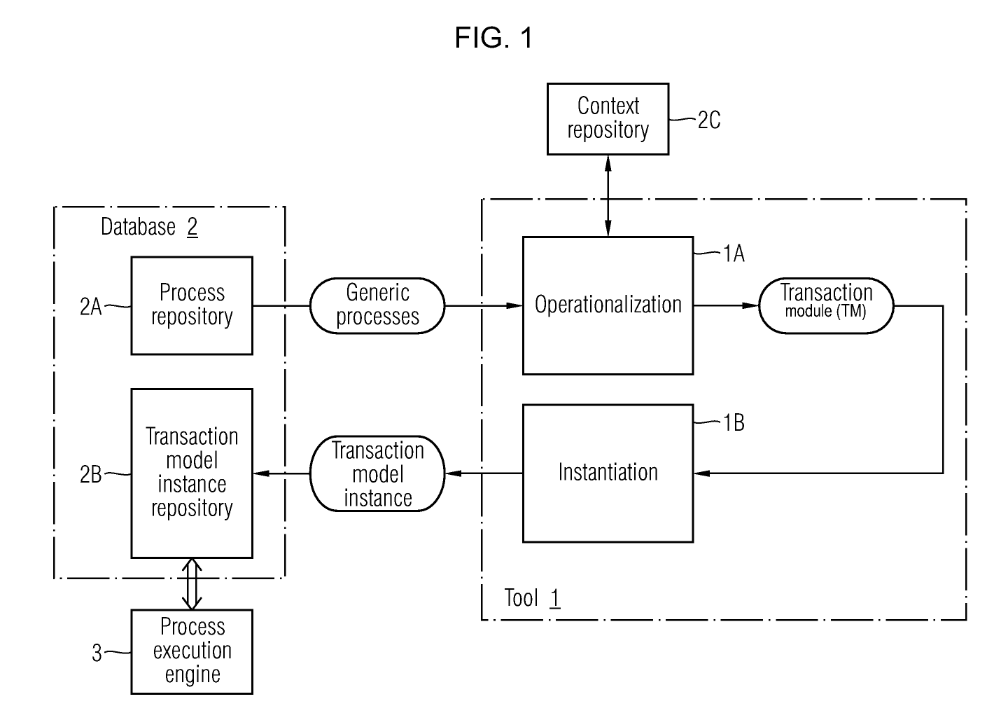

Referring now to the figures of the drawing in detail and first, particularly, to FIG. 1 thereof, the method for transforming generic processes into executable processes according to the present invention can be performed by a tool 1 processing generic processes of a process repository 2A of a data base 2. The tool 1 as shown in FIG. 1 can be a software tool executed on a platform of a data processing system. The data processing system running the tool 1 as shown in FIG. 1 can be connected directly or via a network to the data base 2. The data base 2 as shown in FIG. 1 can, for example be connected to a server providing selected generic processes to the tool 1 according to the present invention. The data base 2 is a memory comprising a process repository 2A for storing generic processes for the same or different contexts of a domain. In a possible embodiment, the data base 2 can also comprise a transaction model instance repository 2B for storing transaction model instances generated by the tool 1 as shown in FIG. 1. In a possible embodiment, the data base 2 can further comprise a context repository 2C. In an embodiment of the data base 2, the process repository 2A comprises a list of generic processes from which at least one generic process can be loaded via an interface into the data processing system executing the tool 1 as shown in FIG. 1. The selection of the generic processes can be performed manually by a user or automatically.

In a possible embodiment, the data processing system running the tool 1 comprises a processor and a user interface, for example a graphical user interface GUI. After loading of the generic processes from the process repository 2A, an operationalization of process elements of the loaded generic processes is performed to generate a corresponding transaction model TM depending on a context which is stored in the context repository 2C. In a possible embodiment, the operationalization is performed by an operationalization unit 1A of the data processing system running the tool 1 as shown in FIG. 1. The generated transaction model TM can be supplied as shown in FIG. 1 to an instantiation unit 1 B of the data processing system running the tool 1 for instantiating the transaction model TM on occurrence of a transaction trigger to generate an executable transaction model instance which can be written to the transaction model instance repository 2B of the data base 2. In a possible embodiment, a transaction model instance can also be copied to the process repository 2A forming a generic process of its own which can be instantiated further, if necessary. The transaction model instance can be selected and executed by a process execution engine 3 as shown in FIG. 1. The process execution engine 3 can be connected via a network to a server comprising the data base 2. Furthermore, a server executing the tool 1 as shown in FIG. 1 can also be connected to this data network. This network can be formed by a local area network LAN, a wide area network WAN or by a system of network such as the Internet.

The context stored in the context repository 2C of the data base as shown in FIG. 1 indicates constraints for an operative unit comprising mandatory context parameters and optional context parameters. These context parameters can be, for example clients, products, services, organizations, locations or complexities of applications and interfaces to other processes.

The generic process loaded from the process repository 2A comprises process elements, wherein each process element can comprise one or several attributes. Each attribute can be adapted manually or automatically to operationalize the respective process element. In a possible embodiment, a consistency check is then performed on the basis of the modified process elements. The adapted attributes of the process element can comprise inputs such as documents or files, roles (e.g. process line manager), documentation, such as templates or guidelines, mile stones (e.g. M280), metrics (e.g. errors after M300), applications, i.e. other used tools, risks such as compliance risks, profiles, services, persons or groups of persons (e.g. “John Smith” or “McS developers Bangalore”) as well as operative units.

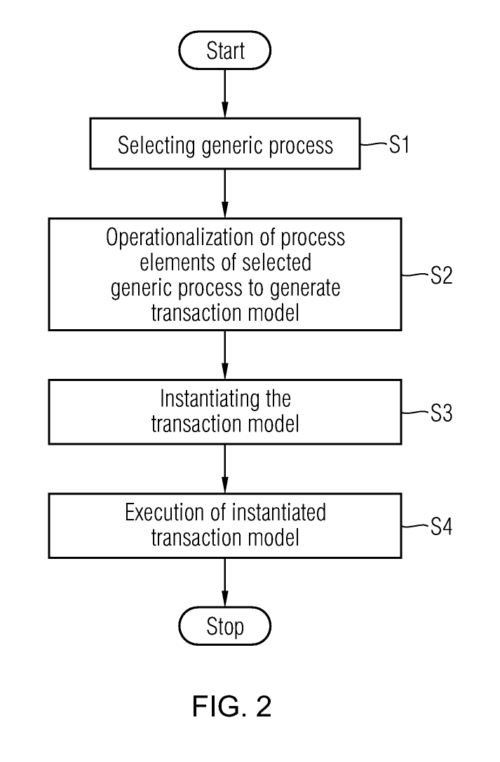

FIG. 2 shows a flowchart of a possible embodiment of the method for transforming a generic process of a domain into an executable process according to the present invention.

In a first step S1, the generic process can be selected from a list of generic processes which can be stored, for example in a process repository 2A of a data base 2 for a given context of the domain.

In a second step S2, an operationalization of process elements of said selected generic process is performed to generate a corresponding transaction model TM depending on parameters of the respective context.

In a further step S3, the transaction model TM is instantiated on occurrence of a transaction trigger to generate an executable transaction model instance which can be loaded to the transaction model instance repository 2D as shown in FIG. 1.

Steps S1 to S3 can be performed by a program executed by a processor of the data processing system.

In a further step S4, the transaction model instance can be executed by a process execution engine 3 as shown in FIG. 1.

A context of a domain is, for example stored in the context repository 2C as shown in FIG. 1 and can comprise a name and a corresponding value or value range, e.g. name=customer and value=company xy. There exist mandatory and optional context parameters of the respective process to be implemented. The context can be formed by a list or a table of context parameters and their corresponding parameter values. In a possible embodiment, the user such as a responsible user for a specific operative unit can specify on existing processes consisting of a series of process transactions having one or several context parameters and their corresponding value ranges. It is possible to change a context of a domain by changing a value of a context parameter or by adding further context parameters or by deleting context parameters. The change of a context does not mean automatically that the task or transaction of the respective process is changed.

The transaction model TM is the process representation for a model of a transaction. The transaction model performs a target process to be implemented.

The data model of a transaction can comprise a name, a creator, a changing user, a version number, a model owner, a model reviewer, a model activation, a reference to a corresponding context. Furthermore, the transaction model TM can comprise a description of a situation which triggers the transaction model comprising conditions, events and inputs. Furthermore, the transaction model TM can comprise a description of results of the respective transaction model such as events, performance, fullfillment criteria and conditions. Furthermore, the transaction model TM can comprise a description of a selected process path of the generic process.

Paths in the transaction model TM are sub-sets of interconnected process chains. The transaction models TM can have a hierarchical data structure which allows the separation or differentiation of projects in sub-projects and the further separation of sub-projects into work packages which can be formed by transactions. These transactions can be described by the transaction model TM. In a general procedure, first a start process model in a generic process description is chosen or selected.

The start function can be selected indicating a triggering event and a corresponding description indicating how, when and why this event triggers the respective transaction performing a precondition in the real-life process.

Furthermore, possible following-functions can be displayed. The following-function can be selected on the same level or a drill-down on a lower level can be performed. After the selection of paths on all levels is completed, the function on the higher levels can be determined. If a copy of an already existing transaction model is used, the selection of the next activity in the transaction model TM can be performed. If an already existing transaction model does not fit or match, a suitable generic process can be selected and checked to derive a suitable follow-up function.

If it is not possible to select a path as requested by the respective context, a change request is posted on the generic process.

A customization of a generic process can be necessary to provide executable transaction models. During customization, the transaction model can be adapted and enriched with further information data such as templates. Each activity of a selected transaction in the transaction model TM is adapted and each function of a process object or process element is adapted correspondingly, i.e. the object is operationalized receiving the necessary information for its instantiation. For example, a process object or process element can receive a link to a corresponding URL, a starter function for a tool or a specific address for a generated output. A process element can be relevant, not relevant or missing.

A transaction model TM can be instantiated to make it executable. For example, persons or person groups can be assigned to specific roles. Optional activities in the transaction model can be selected or suppressed and a corresponding decision can be explained in a description. Optional elements within a certain activity can be selected or suppressed and a corresponding decision can be explained. The physical location of inputs or outputs can be determined and instantiated. Furthermore, it is possible to generate a link between templates and inputs/outputs. After the transaction model has been instantiated, one can get information data from a function allocation diagram.

The context stored in the context repository 2C can comprise factors influencing a set target. Examples for such influencing factors can be the complexity of a product or a service. Further examples are the requests of clients and the size of an operative unit such as an organization or an enterprise.

The generic processes which can be stored in several data bases located in different locations can be customized. The customization adapts the generic process to a real-life environment. The result of the customization of a transaction model TM is forming a binding reference for typical daily life working processes and operations and actions. These customized transaction models TM can be applied without further granulation to daily life events within an organization. With the method and apparatus according to the present invention users, in particular, managers can be supported in monitoring a design and an execution of a process. The method and apparatus increases the efficiency of the system. The method and apparatus according to the present invention allow an accurate time management of a project. Furthermore, the method and apparatus according to the present invention allow an accurate document management for inputs and outputs. Furthermore, a smooth collaboration, i.e. contribution, information and approval of responsible users is provided. Compliance with standards can be provided and an implementation and performance of the respective process can be monitored. It is possible to generate accurate data for process analysis and optimization.

In the following, the present invention is described by a concrete use case in order to demonstrate the individual process operationalization steps. The purpose of the use case is to illustrate the relevant operationalization activities by reference to a concrete example and thus to provide a deeper understanding of the present invention.

The process operationalization activities are supported by means of a suitable tool 1. Analyzing a use case helps to determine requirements placed on such a support tool. In the following, “tool” is taken to mean a specific tool which supports key operationalization steps. The tool forms a software tool for a user.

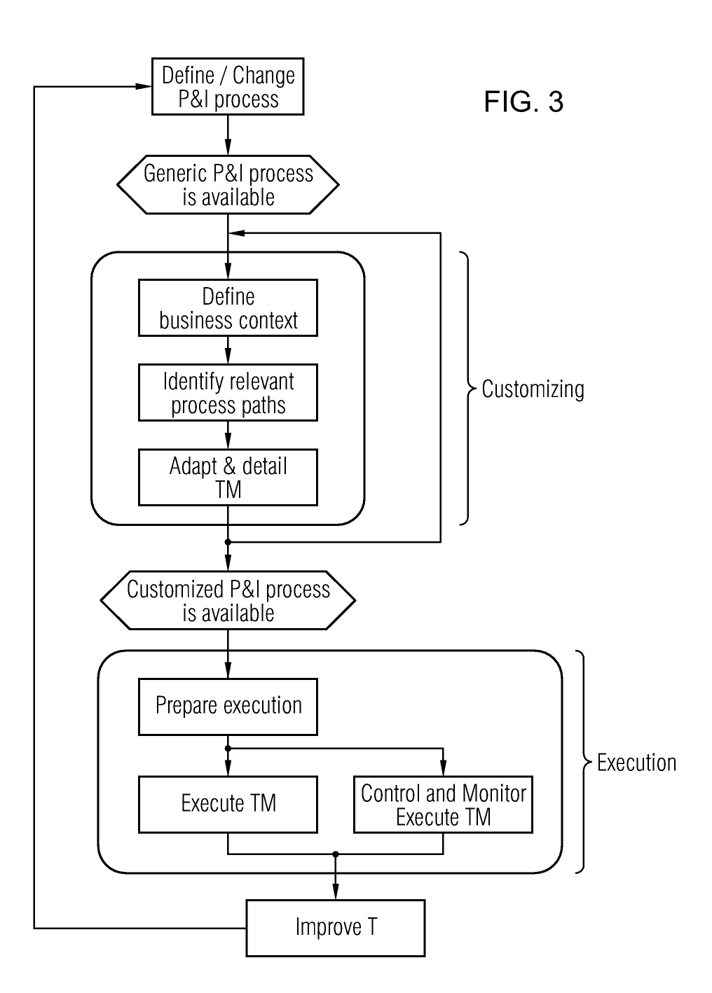

FIG. 3 shows an operationalization process flow. A the same time, the FIG. 3 also provides an overview of the following description because the individual steps are described in the above sequence. The activities and process steps shown are within the scope of the present invention.

In customizing, a generic process can be used as input and modified or expanded to satisfy specific requirements. Three main steps are involved:
Define context
Identify relevant process paths
Adapt & detail TM

TM stands for “Transaction Model”; in other words, for the process description of activities or process paths adapted to a real-world application. The transaction model TM can be formed by a business transaction model (BTM).

Processes such as business or technical processes are designed to fit the relevant constraints. To ensure that this is the case, the constraints (context) are formulated before a process design begins. The formulated context groups together key practice parameters that are to be considered when designing the processes and on which the process environment under review is regularly based.

Once a process context of a domain has been established, the relevant process paths can be selected from a generic process. Taking into account the actual/predefined process flow, the appropriate user such as a line manager selects activities (or process paths) that are relevant for the formulated context.

The selected activities or process paths are then checked to ascertain whether they are appropriate to the context in all aspects and whether they satisfy the set requirements. It is possible to expand a specification and to provide further details (for example, to specify which utilities, tools, templates are used to perform an activity).

Basically, different initial situations may apply when providing a context.
I. There is a parent context to which the new context refers
II. There is no parent context
III. An existing context is to be changed

Typically, the first alternative applies.

These three initial situations are described separately below starting with the first situation.

If there is a parent context to which the new context refers:

Before the context is provided, it is important that an precondition is initiated. The following is a sample extract from a precondition formed by a business mandate:

“The continuous and consistent alignment of the information and communication (I&C) strategy with the business strategy of SIS, i.e. the provision of best in class applications and services supporting the business processes resulting from that strategy, is a prerequisite for working efficiently and effectively within a globally active IT company. As an enterprise dealing across company and geographic boundaries with our customers, partners and other Siemens Groups, Regions, Operating Companies and Corporate Departments (GROCs) this alignment will make a substantial contribution to maintaining and expanding our market position.”

The generation of a context is described step by step below:

In a first step, the typical transactions arising from the precondition are identified. On this basis, the parameters that can be used to suitably characterize and differentiate the transactions are identified. These context parameters are for example: type, customer, complexity. The tool 1 can offer a suitable input field (text).

In a second step, a new context in the tool 1 is created. The tool opens a corresponding input screen for this purpose. This screen can expect the input as described below.

Assigning the parent context. As a result of this assignment, the mandatory parameters of the parent context are “bequeathed” to the new context. The parameters inherited in this way apply equally to the parent and the new context and are displayed accordingly in the input screen. To simplify selection of the parent context, the tool 1 can display all direct parent contexts so that the appropriate context can be selected.

Selecting optional parameters. A user can mark optional parameters also to be used in the new context in a parameter list of the parent context. The initial input of the first step are the basis for selection of optional parameters. The marked parameters are then copied to the new context. Based on the initial input of the first step, it is now checked which other parameters are needed to suitably characterize and differentiate the typical or generic transactions. These can be defined as additional parameters for the new context. For this purpose, a name of the respective parameter and an associated value range can be entered in the input screen. For example, a parameter named “type of activity” can have the following value range: {task, project}.

A concrete value can now be set for the parameters. For example: a “task” value is selected for the new “type of activity” parameter.

The user can specify which of the copied optional parameters and which of the added additional context parameters are mandatory and which are optional. These specifications apply for all further contexts that refer to this new context.

Further fields of the input screen are as follows: Description, Name and Owner. The user can fill these fields in a further third step. By default, the tool can fill the Owner field with the name of the user but this default can be overwritten. The user also fills the “Valid from” and “Valid to” fields. These fields accept only date values as input and specify the dates between which the business context is valid. Unlimited validity is assumed by default.

Saving the context can be performed in a fourth step. In this step the tool 1 checks whether the Name, Description and Owner fields are filled with values. A check can also be made to ascertain whether the values of all parameters are within their value range.

Releasing the context can be performed in a fifth step. For this purpose, the tool 1 displays the business context description just created and can prompt the user to check that the input is correct. At this point, the user has the option of returning to an edit mode or releasing the context.

The new context is saved in the tool 1, and can be visible to all users of the respective tool. The example below illustrates the steps as described above.

Example: The specific application domain is the implementation of “IT demands” in an P&I process.

The first step gives rise to the following sample transactions.

Case No. 1:
Type: Services are performed as a task
Team: Performed by a specialist
Duration: <1 week
Requirements, financial framework and planning data are documented in the task description. No explicit project plan is required.

Case No. 2:
Type: IT customizations are performed as a project
Team: Performed by a team, the team is headed by the project manager
Duration: 2 to 8 weeks
The project manager prepares the project plan based on a predefined template

The description below relates to case no. 1.

The brief descriptions of the business transactions (outside the tool) can be recorded. The result can be, for example, that the “duration” and “type” parameters are particularly suitable for characterizing and differentiating the respective transactions.

The key contents of the context are now described in the second step. The parent context is first selected. The mandatory parameters of the parent context results are copied, for example, in the following list of parameters and values.

| | |
|---|---|
| Name of the | |
| business context | |
| Owner | John Doe |
| Parent business | IT |
| context | |
| Description | |
| Valid from | |
| Valid to | |

Parameters

| | |
|---|---|
| Scope [inherited] | GIO |

By means of a suitable marking (the “[inherited]” postfix in the above example), the tool 1 can indicate that the respective parameter has been “inherited” from the parent context as a mandatory parameter.

The optional parameters to be used in the new context can then be selected from the parent context. This is the “customer” parameter in our example. Consequently, this parameter is created in the new context but the postfix indicates that the parameter has been copied as an optional parameter from the parent context. The result is shown in the table below.

| | |
|---|---|
| Name of the business | |
| context | |
| Owner | John Doe |
| Parent business context | IT |
| Description | |
| Valid from | |
| Valid to | |

Parameters

| | |
|---|---|
| Scope [inherited, | GIO |
| mandatory] | |
| Customer [inherited, | Daimler |
| optional] | |

In a further step a check is made to ascertain which other parameters are needed to suitably characterize and differentiate the transactions. In our example the following parameters are involved: type, complexity, duration and volume. When these new parameters are created, the tool automatically prompts for definition of the associated value range for each parameter. As in the above example, this can result in the following definitions:
Type: {task, project}
Complexity: {low, medium, high}
Duration: {<1 week, 1-3 weeks, >3 weeks}
Volume: {<$10000, > $10000}

Once the value ranges for the new parameters have been defined on the tool 1, the parameters are displayed on the input screen for the new context where concrete values (from the value range) can be assigned to them. The result of these steps looks like this.

| | |
|---|---|
| Name of the business | |
| context | |
| Owner | John Doe |
| Parent business context | IT |
| Description | |
| Valid from | |
| Valid to | |

Parameters

| | |
|---|---|
| Scope [inherited] | GIO |
| Customer [inherited, | Daimler |
| optional] | |
| Type | Task |
| Complexity | Low |
| Duration | 1-3 weeks |
| Volume | <$10000 |

In the third step an owner entry can be checked and corrected if necessary. The name of the new context can also be entered. A description is added and the appropriate dates are set. The result is shown in the table below.

| | |
|---|---|
| Name of the business | Implement IT demand |
| context | |
| Owner | John Doe |
| Parent business context | IT |
| Description | Implementation of GIO- |
| | specific IT demands by |
| | milestone M200. |
| Valid from | Jan. 03, 2008 |
| Valid to | |

Parameters

| | |
|---|---|
| Scope [inherited] | GIO |
| Customer [inherited, | Daimler |
| optional] | |
| Type | Task |
| Complexity | Low |
| Duration | 1-3 weeks |
| Volume | <$10000 |

In the given example no value is entered for “Valid to”. This means that the context is valid for an unlimited period.

In the process described above, it was assumed that there is a parent context to which the context to be defined refers. If this is not the case it is proceeded as follows.

First the typical or generic transactions arising from the respective mandate and associated parameters are provided. This can be done as described above.

To create a new context, the tool 1 can open a corresponding input screen for this purpose. This screen expects an input as described below.

If the tool 1 cannot provide any parent contexts, it informs the user accordingly and prompts for confirmation that a context is to be created without reference to a parent context.

It is then checked—based on the initial input—which parameters are needed to suitably characterize and differentiate the generic transactions. These can be defined as parameters for the new context. For this purpose, the name of the parameter and its associated value range can be entered in the input screen. For example: a parameter named “type of activity” can have the following value range: {task, project}.

A concrete value for the new “type of activity” parameter.

The user can now specify which of the parameters are mandatory and which are optional. These specifications apply for all further contexts that refer to this new context.

After the new context has been defined and saved in the tool, it is visible to all users of the tool. The result is illustrated by the following example.

| | |
|---|---|
| Name of the business | Implement IT demand |
| context | |
| Owner | John Doe |
| Business mandate | [Link to the description |
| | of the business |
| | mandate] |
| Description | Implementation of GIO- |
| | specific IT demands by |
| | milestone M200. |
| Valid from | Jan. 03, 2008 |
| Valid to | |

Parameters

| | |
|---|---|
| Scope | Vienna |
| Type | Task |
| Complexity | Low |
| Duration | 1-3 weeks |
| Volume | <$10000 |

In contrast to the previous examples, the mandate is referenced instead of the parent context. Neither is there any differentiation between inherited and newly defined parameters. No parameters are inherited because there is no parent context.

This may be necessary to change an existing context if the mandate or other key factors influencing workflows have changed. Basically, a context cannot be changed once it has been released. In this case, a copy of the context to be changed must be created and then edited.

First the typical transactions arising from the mandate and the associated parameters are identified. This is done as described above.

The tool 1 is then opened and displays a list of existing contexts. The tool 1 can offer suitable search and filter mechanisms so that contexts can easily be found. A context can be selected and a copy of it can be generated.

The tool 1 opens the copy in a corresponding input screen. When the copy is created, the tool copies all values of the original context by default. These values can now be changed. Further fields of the input screen are as follows: Description, Name and Owner. By default, the tool 1 can fill the Owner field with the name of the user but this default can be overwritten.

The user now fills the “Valid from” and “Valid to” fields. The “Valid from” filed in the new business context (=copy) and the “Valid to” field in the old business context (=original) must be filled. The tool provides suitable input options and ensures that none of the fields can be omitted.

The formulated context is the basis for selection of those activities relevant to the concrete business case. This is illustrated below by reference to the P&I process.

Sufficient familiarity with the P&I processes is needed to be able to select its relevant activities (this is, in fact, a precondition). (This applies in general and the P&I process is simply a concrete illustration.) Familiarity means that:
the purpose of the P&I process is known
the sub-processes of the P&I process and their interaction are understood the activities in the P&I process are known in full.

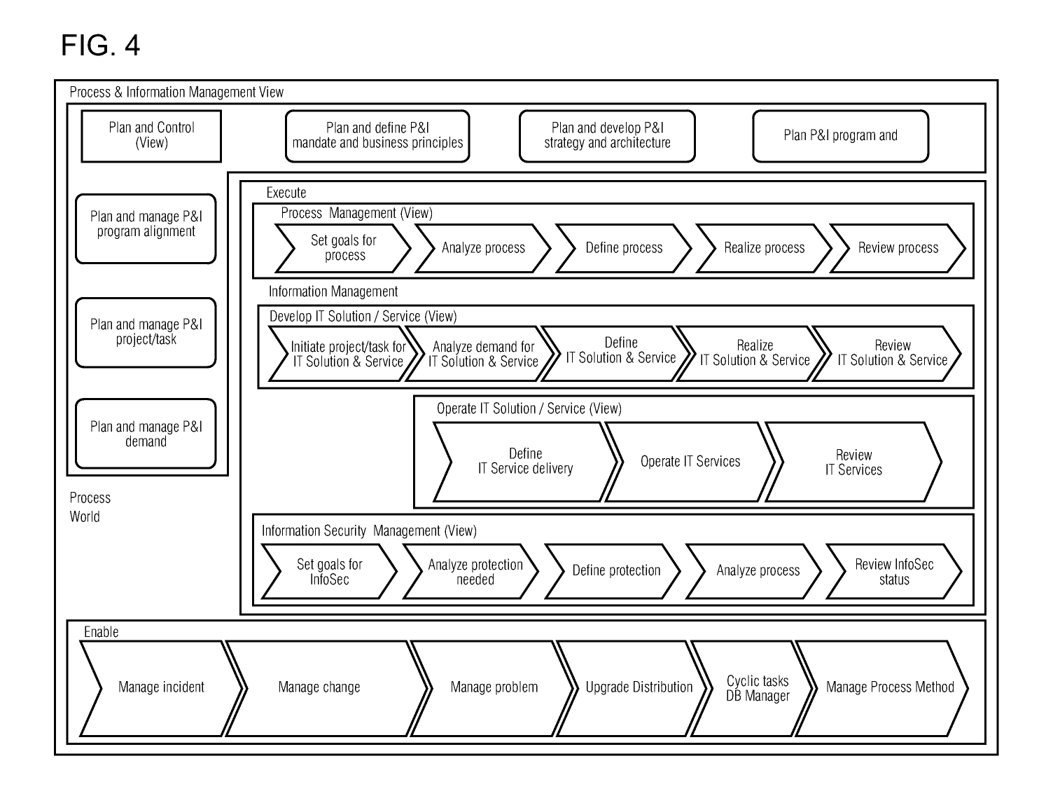

First, the user can navigate in the tool 1 to the starting point of the process to be customized. Example: FIG. 4 shows a generic P&I process.

A context is then selected for assignment to the transaction model to be created. For this purpose, the tool 1 offers the user a suitable list of available contexts from which one context must be selected.

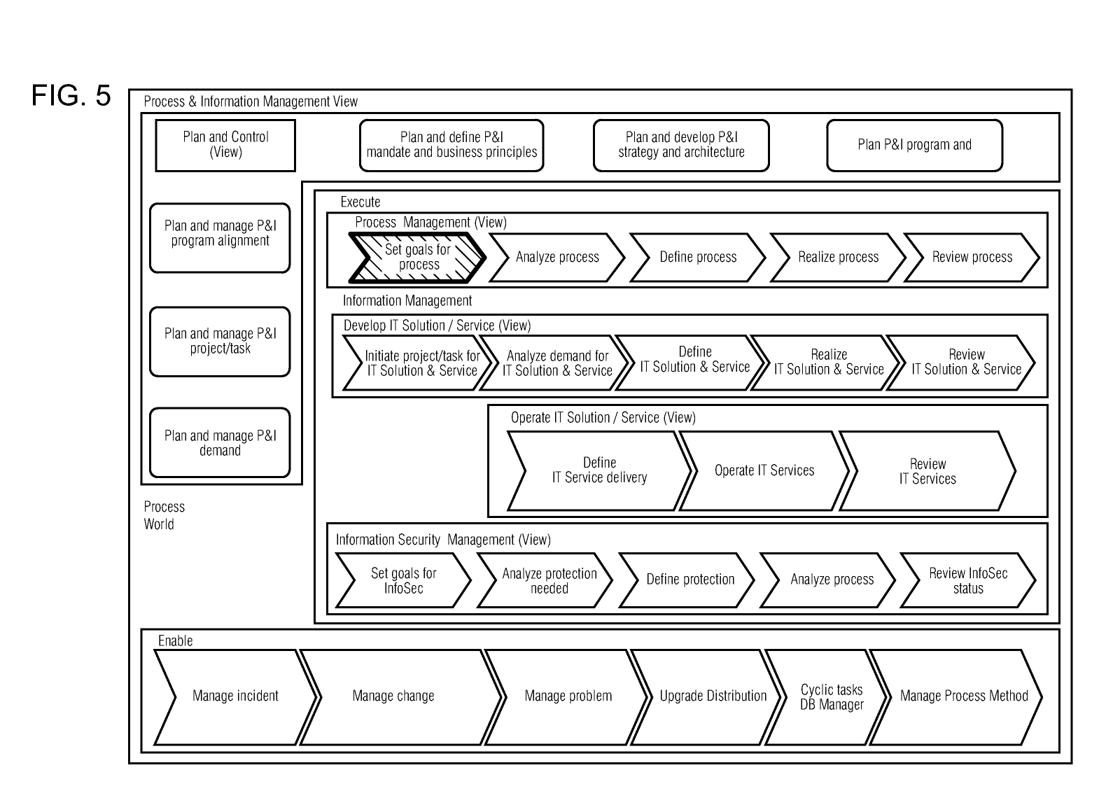

By default, the user of the tool 1 is entered as the owner of the transaction model TM to be created but this default can be overwritten. The function or sub-process that corresponds to the start of the transaction model can be now selected. To do this, the user marks a function (or sub-process) and confirms by means of a suitable tool function that the highlighted function is the “start function”. This is illustrated by FIG. 5, again by reference to a P&I process.

In FIG. 5 it can be seen that the function (or sub-process) with the red border has been marked as the start function. In the present example, this is also the logical start of the process but the start function may also be located in a logical later part of the process.

The tool 1 guides a user through the individual customizing steps. Each following step can e.g. be reached by means of a suitable “Next” button. The following occurs when the button is pressed.

The tool 1 establishes whether the marked start function has one or more predecessors. Two situations may result from this check.

In a first situation, the function (or sub-process) has no predecessor—in this case the marked start function is a “genuine” starting point and the tool proceeds to prompting as described below.

In a second situation, the function (or sub-process) has one or more predecessors—in this case the tool informs the user accordingly and prompts the user to decide whether the currently selected start function is to be retained or a different function is to be selected as the start function.

The tool prompts the user to specify what happens when the selected start function is executed. In other words, a clear description is needed of the necessary and adequate conditions that must be fulfilled so that the start function can be executed in practice. The tool offers a suitable input screen which displays the name of the start function and provides an input field for the necessary and adequate start conditions. If the check indicates that the second situation applies, the tool automatically copies all start function input into the text fields for the description; however, the user can be able to modify this input. Once input is complete, the user confirms the input and the tool ensures that the input field for the (necessary and adequate) start conditions is not blank.

In the next step the tool shows a new display to the user (after the “Next” button has been pressed) where the follow-on functions for the selected start function are defined. In the simplest case (see below for more complex options) the tool determines the follow-on function automatically.

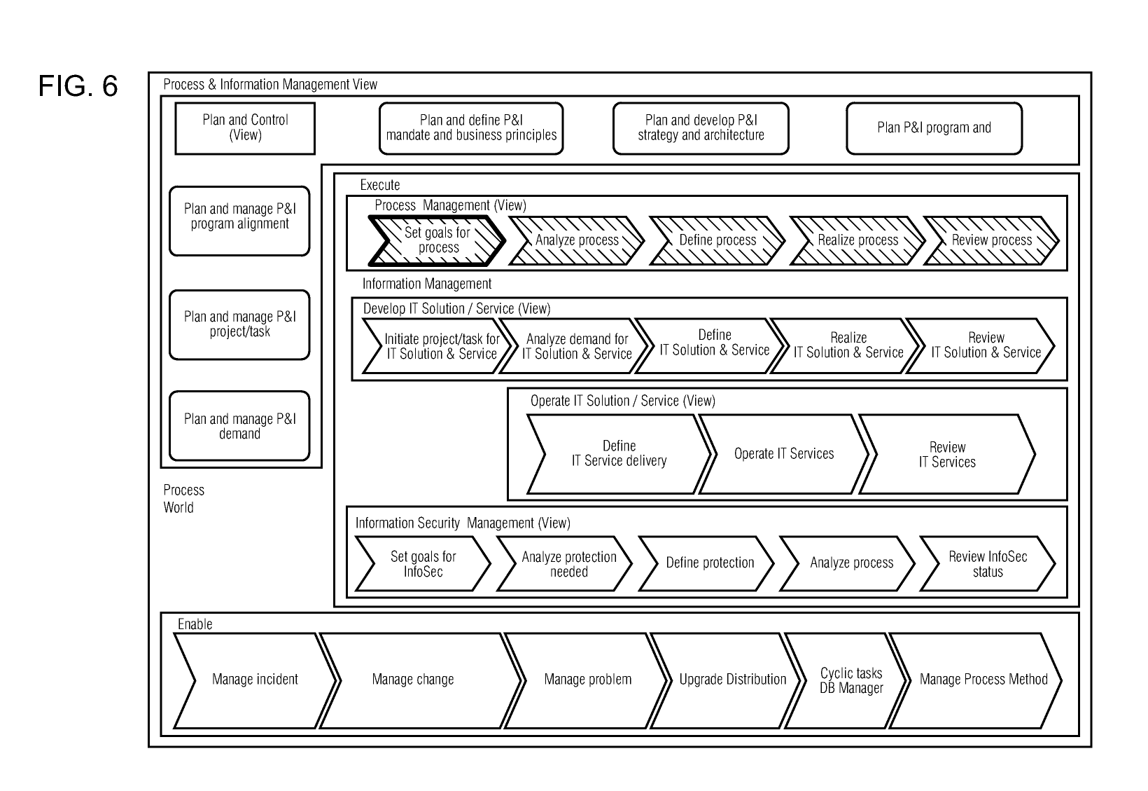

In FIG. 6 it can be seen that the function (or sub-process) with the red border is marked as the start function. The tool has then automatically marked those other functions (or sub-processes) that must also be executed when the start function executes. The above example is kept simple in that the selected start function (bordered in red) is followed by further functions (or sub-processes) in chronological sequence. In other words, there are no branches which require that the user makes a decision.

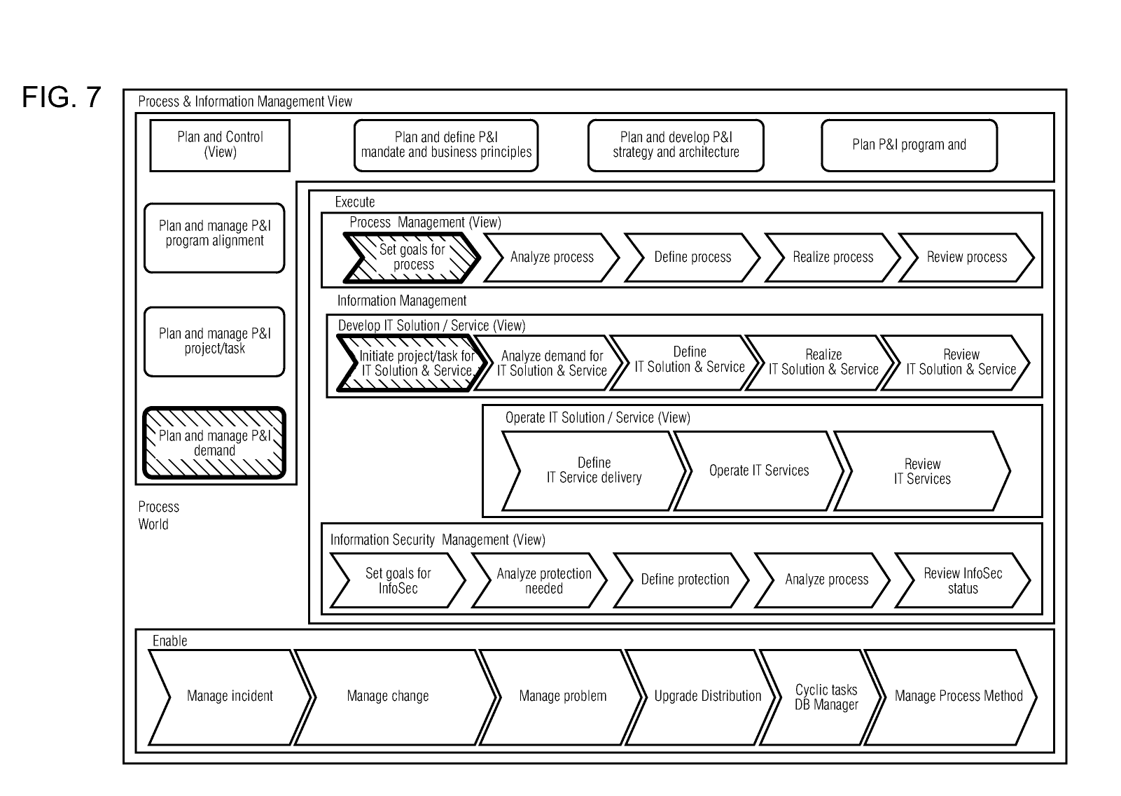

In the next example (shown in FIG. 7) the “Plan and manage P&I Demand” function has been selected as the start function. In response, the tool offers two functions as possible continuations. The red border marks the selected start function and the blue border the possible continuations.

In the tool input window shown in FIG. 6, the user is prompted to decide which of the functions (or sub-processes) surrounded by a blue border is to follow on after the start function. One or both of the functions in the above example can be selected.

Several situations can occur depending on the specific start function selected. There is only one possible continuation (see FIG. 6) There are several possible continuations and the user must select at least one of them. However, one can also select several or all follow-on functions There are several possible continuations of which just one is to be selected

Case a) is the simplest situation and is illustrated in FIG. 6. In this case, the tool 1 automatically selects the only possible follow-on function and displays it accordingly. Not only the function that directly follows the start function is displayed but all further functions that must succeed the follow-on function.

In case b), the tool 1 suitably highlights all possible continuations—see FIG. 5. The user selects the follow-on function(s) and confirms his/her selection. The tool ensures that at least one of the possible follow-on functions has been selected.

In case c), the tool 1 suitably highlights all possible continuations (as in case b) but the kind of highlighting (e.g. coloring) indicates that genuine alternatives are meant; in other words, only one follow-on function may be selected. When a follow-on function is selected, the tool removes the highlighting of all other currently highlighted functions. The tool ensures that just one function is selected and confirmed as the follow-on function.

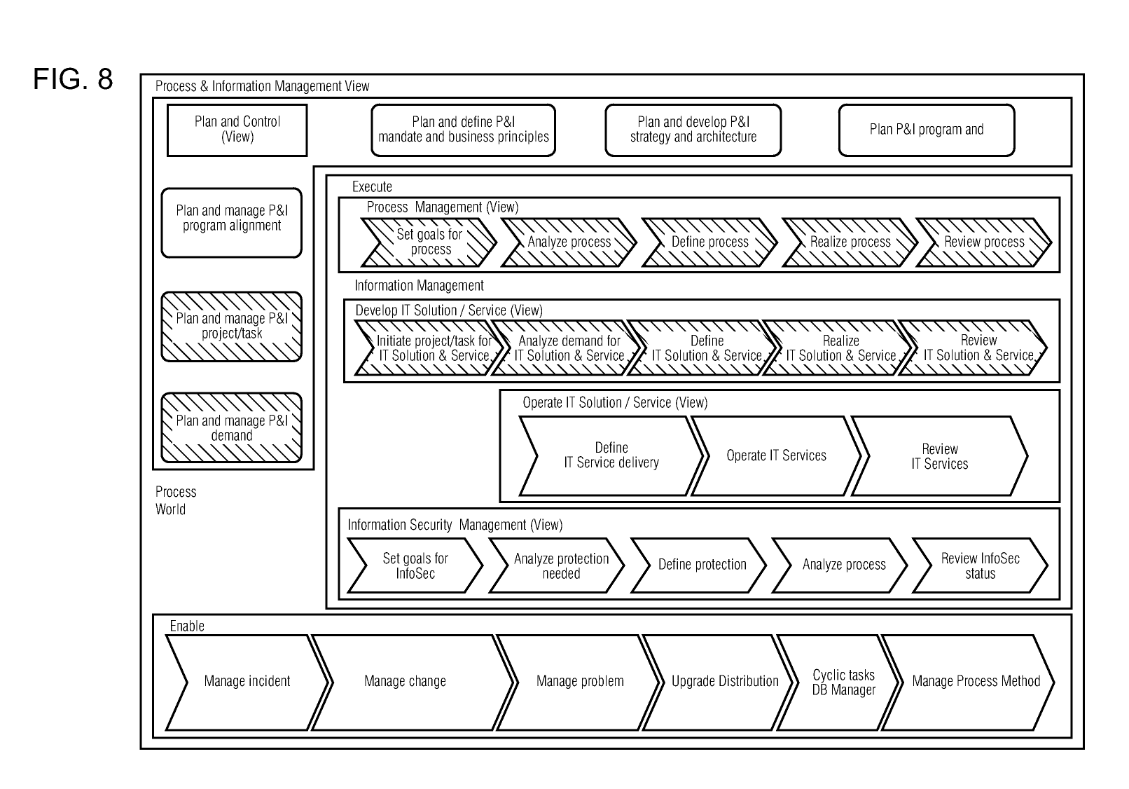

In the present example, it is assumed that both follow-on function candidates marked with a blue border in FIG. 7 have been selected and confirmed. The tool 1 then searches for all functions that must necessarily succeed the two selected follow-on functions. The result is displayed by the tool as shown in the example of FIG. 8.

The result of the above steps (in the sample P&I process) is that the relevant sub-processes have been selected on the top level. However, the sub-processes may contain alternative process paths. Consequently, the selection of functions/sub-processes on the top level must be continued on the lower, more detailed levels of the process description. This leads to the next step.

Clicking on the “Next” button takes the user to the next step where selection of the relevant functions is continued on the detailed level. For this purpose, the tool checks the detailed process descriptions and makes a systematic search for functions which have more than one follow-on function. The tool displays the functions found and the follow-on function selection options.

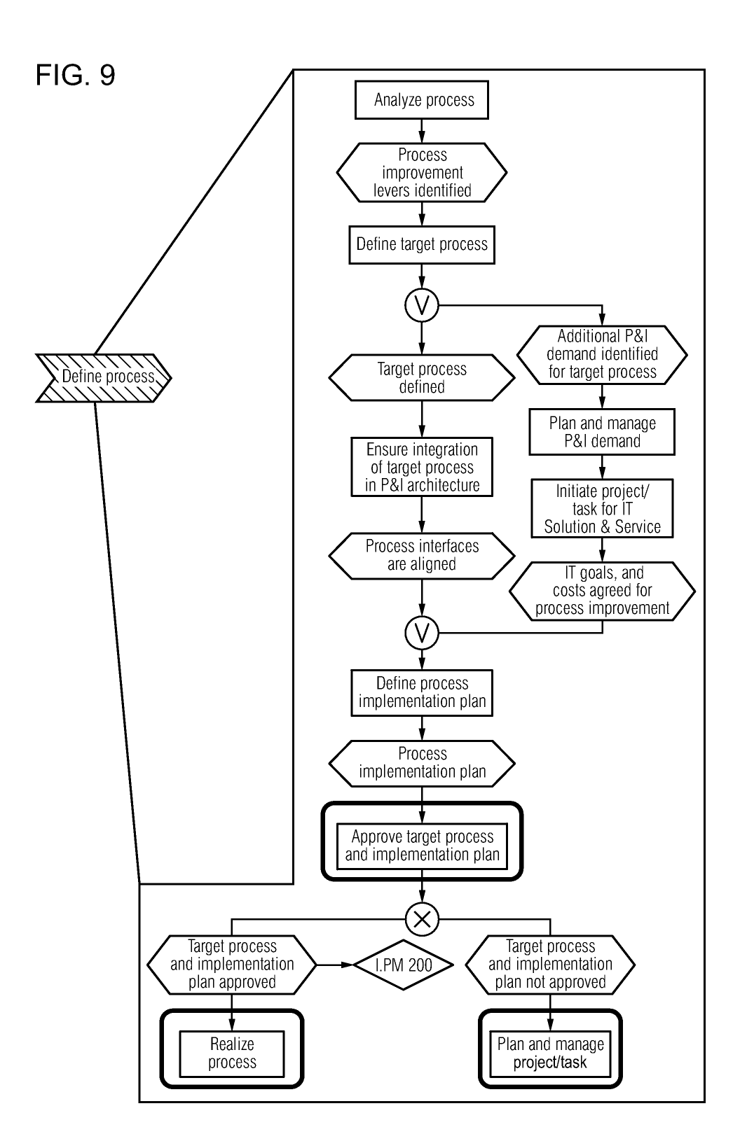

FIG. 9 shows, by way of example, a transition from a top-level display to the next, more detailed level. In our example, the tool 1 has found—in the sub-process with the red border—a function that has more than one follow-on function.

FIG. 9 shows an example of customizing continued on the detailed level of the process description. The tool 1 automatically selects the sub-process with the red border on the left because it contains a function (bordered in red) that has more than one follow-on function (bordered in blue).

The display system is identical to that used in the previous figures. In other words, the red border indicates the function currently under consideration and the differently colored border (blue, for example) indicates possible follow-on functions. In addition to this information the tool 1 also indicates the hierarchical assignment. As a result, it can be seen at all times which sub-process is currently under consideration and how it can be reached from the top level of the process. This approach is recursive; i.e. the tool searches recursively for all functions and sub-processes contained in all sub-processes selected on the top level.

The tool 1 prompts the user to define a post-condition once it reaches an end point after the recursive process search as described above has been completed and a function that has no further follow-on functions has been found. By default, the user gives the post-condition the name of the function that represents the end point. An input field is shown in which the name of the post-condition must be entered. When a save is performed, the tool 1 can check whether any of the fields are blank and, if so, prompts for an entry.

Once the above steps are completed, all functions to be executed by default have been selected. The situation that causes the start function to be executed is defined, and the status or results achieved at each endpoint (i.e. each function that has no follow-on function) are defined. The tool has ensured that the relevant paths have been selected from the predefined process paths and that the sequence of functions has not been changed in any way. The end result is known as a “transaction model” and is assigned to a context and to a process (to the P&I process, for instance). The transaction model TM obtained in this way is further refined and detailed in a subsequent “Adapt and detail transaction model” activity; the result of this step is also referred to as a “transaction model”.

Processes can be basically suited to their specific purpose. In other words, the process paths selected are able to satisfy all needs and requirements arising from the respective context and the real-world situation. However, it may also be that, from the user viewpoint, none of the possible follow-on functions offered by the tool 1 is suitable. If this is the case, a change request can be submitted to the owner of the process. The request contains, in particular, a description of the desired change. As soon as the modified process is available, the procedure is the same as described above.

Changing an existing transaction model TM such as a business transaction model (BTM) can be performed because of the following reasons:
The parent process was changed
The context has changed
Other influencing factors have changed

In cases a and b, the tool 1 can provide substantial help in identifying the change requirements because the tool is aware of the context and process associated with each transaction model. Case c differs in this respect because the tool cannot detect the need for a change. Each of the three cases is described below.

If, for example, a parent process has changed, the tool 1 is aware of this fact due to the altered version level. It is assumed that a description of the changes to the process is available in the tool 1 in addition to the new process version. The tool identifies all transaction models that are based on the respective process (i.e. that are derived from this process). The owners of the transaction model TM are contacted by the tool (by email, for example), are informed that the P&I process has changed, and are provided with a description of the changes. The tool also lists all transaction models that need to be checked (because they are based on the modified process). The tool 1 can set a deadline by which checking and, if necessary, revision of the transaction model must be completed.

The owner of the transaction model TM (typically a line manager), i.e. a respective user to which the transaction model is assigned checks the changes to the process and then checks the relevant transaction models. If it is discovered that a transaction model TM needs to be changed, the following procedure is adopted.

The existing transaction model TM is opened and a new version of the model is created in the tool 1. In this step the tool 1 automatically queries the date until which the “old” version of the transaction model is to remain valid and the date as of which the new version is to apply. This data is stored in the transaction models. The new transaction model TM is derived from the process as described above.

A validity end date for the “old” transaction model and a validity start date for the new transaction model are set—this data is also stored in the transaction models.

If a context has changed, the tool 1 identifies all transaction models that refer to the context and informs the owners of the transaction models (e.g. by email). The appropriate line manager (=owner) then checks the effect of the changed context on the transaction models. It may then be necessary to modify the transaction model but it is also possible that no substantive change to the transaction model is required. Both these situations are described below.

If, despite the changed context, there is no need to make any change to the transaction model TM, the new context is assigned to the transaction model and the model is saved in a memory.

If the changed context means that it is necessary to modify the transaction model TM, the model can be loaded in the tool and processed in an Edit window. All editing options are offered (colored highlighting, selection of follow-on functions, etc.). The tool 1 also permits direct navigation to the function that needs to be changed. In this case, it is not necessary to work through all the steps in the Edit window. Instead, it is possible to focus on what needs to be changed. The transaction model is saved once the changes have been completed. A new version of the transaction model TM is created but the previous version can be loaded at any time.

A validity end date for the “old” transaction model and a validity start date for the new transaction model are now set—this data is also stored in the transaction models.

If other influencing factors have changed, neither a change to the process nor a change to the context necessitates modification of the transaction model. The procedure is the same as described in the last section above; i.e. the transaction model is modified in the Edit window of the tool and is then saved. A new version of the transaction model is created but the previous version can be loaded at any time.

As in the other situations, a validity end date for the “old” transaction model and a validity start date for the new transaction model are set—this data is also stored in the transaction models.

The selected transaction model TM contains various objects, e.g. functions, milestones and—on the detailed level—possibly also descriptions, information on the roles involved and on the relevant templates and tools. In “Adapt and detail transaction model” it is a question of adapting or supplementing the transaction model on this level of detail so that it is suitable for the projects/tasks in the business context. The relevant work steps are described below.

The starting point for “Adapt and detail transaction model” is the selected transaction model which is the outcome of “Identify relevant process paths”. For purposes of the present description, we use the example from the last section.

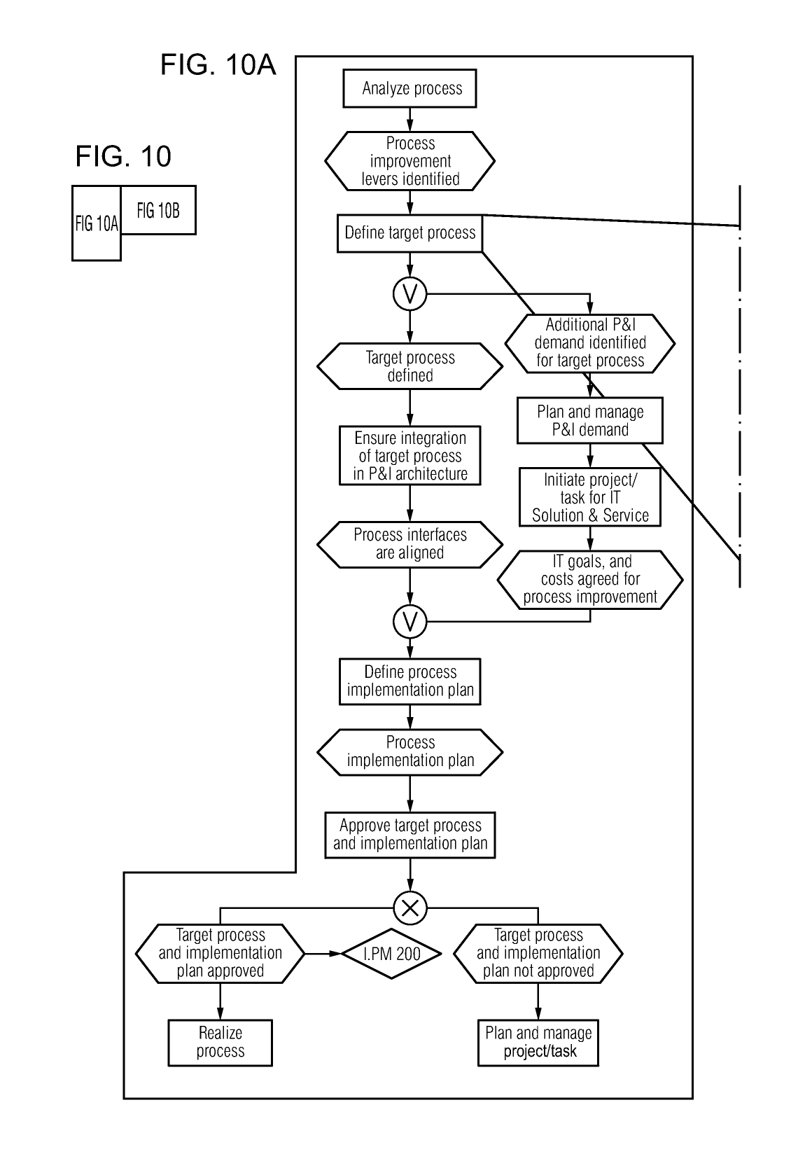

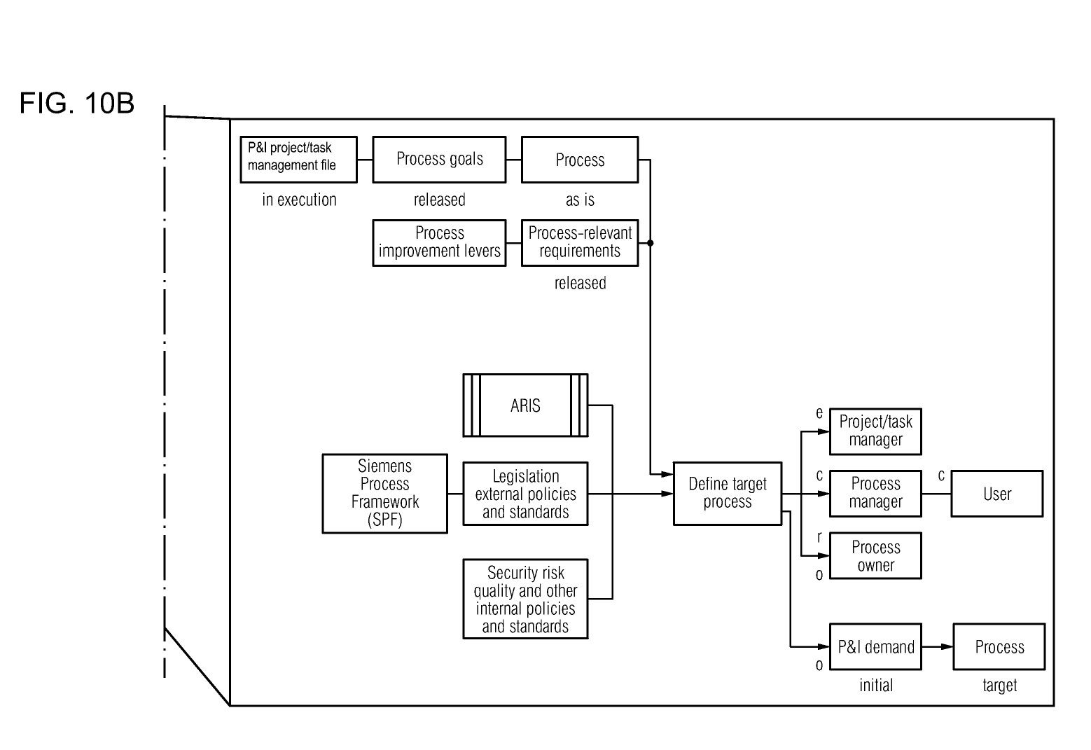

FIG. 10 shows a chronological sequence; here an object is selected in the tool—in this case, the “Define target process” activity. This is shown on the left. As a result of this selection, the tool switches to the detailed display for the selected object shown on the upper right.

The selection shown in FIG. 10 differs from the “selection” in the “Identify relevant process paths” section. Here, it is a matter of selecting the relevant functions. The goal is now to check the information in the detailed display (upper right) to ensure that it is correct, complete and shown in adequate detail. This check is described below.

The detailed display of the “Define target process” activity includes several groups of objects, e.g. roles (yellow), inputs/outputs (white) and documented knowledge (blue). For the defined context and with a view to practical use (business case), each of these elements is checked to ascertain whether it is suitable and correct—various situations may result.

An element shown is relevant but one of the attribute needs to be adapted. This is the standard situation expected in the “Adapt and detail transaction model” step.

An element shown is not relevant.

Example: The output “P&I demand” is not required by default.

A relevant element is missing.

Example: Assessment results should always be used as part of input.

Given the real-world complexity, the granularity of the description is too coarse.

Example: “Define target process” includes various sub-steps that should be shown explicitly.

These basic options (a-d) are illustrated below by means of examples.

Case a: If an element shown is relevant but one of the attribute needs to be adapted

Example: “SPF” as documented knowledge is classified as directly relevant (i.e. as mandatory).

In the detailed process display the user marks the object whose attributes are to be adapted. A screen then opens in which all attributes of the object are shown. The user then can change the relevant attribute in this screen.

Example: In the detailed process display the user marks the object “SPF”; a screen then opens in which all attributes of the object are shown. In this screen the user changes e.g. the relevant attribute of the object from “optional document” to “mandatory document”.

The tool 1 checks the consistency of the modified data. A check is made to ensure that all inputs required by other activities are actually generated as outputs. The valid modelling rules are also checked—as in all consistency checks. If the consistency check is successful, the tool 1 applies the change, closes the screen, and shows the new attributes in the detailed display.

Example: The description of the “Process goals released” input is to be supplemented.

In the detailed process display the user first selects the “Process goals released” input; a screen then opens in which all attributes of the object are shown. The user then adapts the description of the object in this screen.

The tool then applies the change and closes the screen.

Case b: If an element shown is not relevant

Example: The output “P&I demand” is not to be required.

In the detailed process display the user first marks the “Define target process” activity; a screen then opens in which all attributes of the object assigned to the activity are shown. The user deletes the entry for “P&I demand” in this screen. The consistency check is performed. The tool 1 checks whether the “P&I demand” output was a mandatory output in the standard process. If so, the tool 1 informs the user accordingly and prompts him/her to correct the change. A check is also made to ascertain whether “P&I demand” is a mandatory input for one of the following activities. If so, the tool 1 informs the user accordingly. The basic process logic must be considered.

The tool 1 applies the change, closes the screen for the “Define target process” object and no longer shows “P&I demand” in the detailed display.

Case c: If a relevant element is missing

Example: The “Assessment results” element that has not been used up to now is to be used as part of input.

In the detailed process display the user first marks the “Define target process” function. Then, a screen (object editor or object diagram) opens in which all attributes assigned to this function are shown.

The object editor shows all attributes of the object. The attributes are, in particular, the inputs and outputs of the function. The existing inputs/outputs are displayed and can be changed here, e.g. to add the “Assessment results” input, the user can press a suitable “button” in the object editor. A text can then be entered in a text field to describe the input. In our example, the text “Assessment” can be entered in this field. The tool 1 then shows a list of outputs that have already been generated in the logically preceding functions and which include the word “Assessment” in their name. The user can then select the appropriate output from this list. In the given example the list includes the “Assessment results” object which the user then selects. This object is displayed in the object editor as input for the “Define target process” function. The tool 1 searches “intelligently”; in other words, suitable outputs with a similar name are also identified and offered for selection. If the tool 1 does not find any suitable output, the search can be modified accordingly. If the user is unable to find a suitable input, the tool 1 provides the option of creating a new input. For this purpose, the object must be added as output in one of the logically preceding functions, or—in exceptional cases—the object must be classified as input by a process-external source (e.g. by a customer or suppler).

This is how the tool prevents the creation of inputs that are not the output of a preceding activity.

If necessary, the user can change or add further attributes and then confirm them. In a consistency check the tool 1 checks whether the attributes are complete.

If the consistency check was successful, the tool 1 applies the changes, closes the screen and displays “Assessment results” as input for the “Define target process” activity.

In an embodiment it is possible to assign the following elements to functions and sub-processes (such as “Define target process”):
Inputs (e.g. documents, files, information)
Outputs (e.g. documents, files, information)
Applications (i.e. tools)
Documentation (templates, guidelines)
Milestones (e.g. M280)
Metrics (e.g. errors after M300)
Sub-processes (e.g. “Analyze Process” as a sub-process of the P&I process)
Roles (e.g. Process Manager)
Persons or groups of persons (e.g. “John Smith” or “MacOS X Developers Bangalore”)
IKS risk (e.g. profile)
Compliance risk
Business risk
Services

The screens for the “Activities” and “Processes” object types can propose the listed objects. Entries for all objects are made in basically the same way—as described above. If “Activity” or “Processes” elements are added, this means in practice that “Define target process” is described in detail or is subdivided into clearly defined sub-steps. Adding “Metrics” is described in detail below.

As described above, objects are not created, changed and deleted in the overview (FAD) but in the object editor (or in suitable object diagrams). In a possible embodiment, the object editor is able to work with the following objects:
Data model (FB model, BOT information model)
Application system model
Risk model
Metrics model
Service model
Organigram
Role model

Metrics can be assigned to functions or sub-processes. Consequently, metrics are managed in the tool 1 with reference to an associated function and an associated sub-process. This assignment represents a substantive relationship because certain quantitative aspects of function or sub-process execution are measured by the metric.

It is proceeded as follows to define a new metric:

The screen (object editor) for the function or sub-process to which the metric is to be assigned is opened.

The screen proposes, among other things, the assignment of metrics to the particular activity.

The user indicates that a new metric is to be created and the tool responds by opening an entry screen (=object editor) for metrics. The screen can include in a possible embodiment the following fields:
Strategic goal/driver
Metric (name of the metric)
Business Unit
Objective
Definition
Calculation
Unit
Frequency (of data collection and reporting)
Figures (actual and target values)
Responsible for target achievement
Responsible for tracking/reporting

The user fills the screen fields and confirms his/her input.

The user then checks the field for the owner of the metric and changes it, if necessary. The tool 1 enters the name of the user as the owner by default. In a consistency check the tool 1 checks whether values have been entered in all fields.

If the consistency check is successful, the tool 1 closes the input screen for the metric and returns to the previous display. The newly created metric can be displayed.

The tool 1 can inform involved users (responsible for target achievement, responsible for tracking/reporting) of the new (or modified) metric by suitable means.

Example: The result of metric definition for the “Hit rate” metric can look like this:

| | |
|---|---|
| Strategic goal/driver | Efficiency of acquisition |
| Metric | Hit rate |
| Business Unit | PSE |
| Objective | Optimize the Sell process (sell to |
| | customer product/system/services or |
| | sell project/solution) in order to save |
| | costs/resources. |
| Definition | Value of offers relative to value of |
| | signed contracts. Signed contracts |
| | (C.SP060 or PM070) are set in |
| | relation to submitted offers |
| | (X040/C.SP050 or |
| | Q.C.Pm040/PM050). Shows quality |
| | of offer process. |
| Calculation | Hit rate = (Value of Signed Contracts)/ |
| | (Value of Submitted Orders) * 100 |
| Unit | % |
| Frequency | Quarterly (min), calculation period to |
| | be defined by GRO |
| Figures | Actual: 52% |
| | Target: 60% |
| Responsible for target | Head of GRO |
| achievement | |
| Responsible for | BA of GRO |
| tracking/reporting | |

The tool 1 can provide various views to support customizing.

The tool 1 provides overviews of the processes. Examples are given in FIG. 9 (on the left and right of the figure).

The tool includes an object editor in which the attributes of objects can be modified.

The features of the editor are described above.

The tool offers a dedicated collaboration view as an alternative to the overview in the right part of FIG. 9.

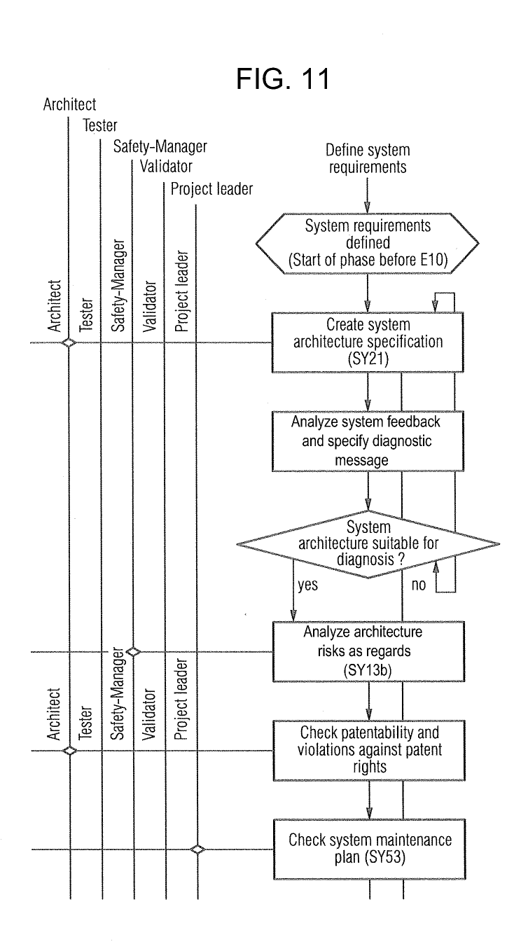

FIG. 11 below shows an example of a collaboration view. (FIG. 11 is intended to show the systematic approach; its graphical design is not of primary importance.)

If in terms of the real-world complexity, the granularity of the description is too coarse

Example: “Define target process” includes various sub-steps that should be shown explicitly.

When activities or processes are described, consideration can be given to the following. The descriptions should be brief and clear on the one hand but should be detailed enough to serve their purpose on the other. From the viewpoint of process users, this means that the description should include all relevant and necessary activities and individual steps but not things that can be taken for granted. To ensure that this is the case, the knowledge/experience of the users must be taken into account. In the present use case, it is assumed that a detailed description of the “Define target process” activity is required.

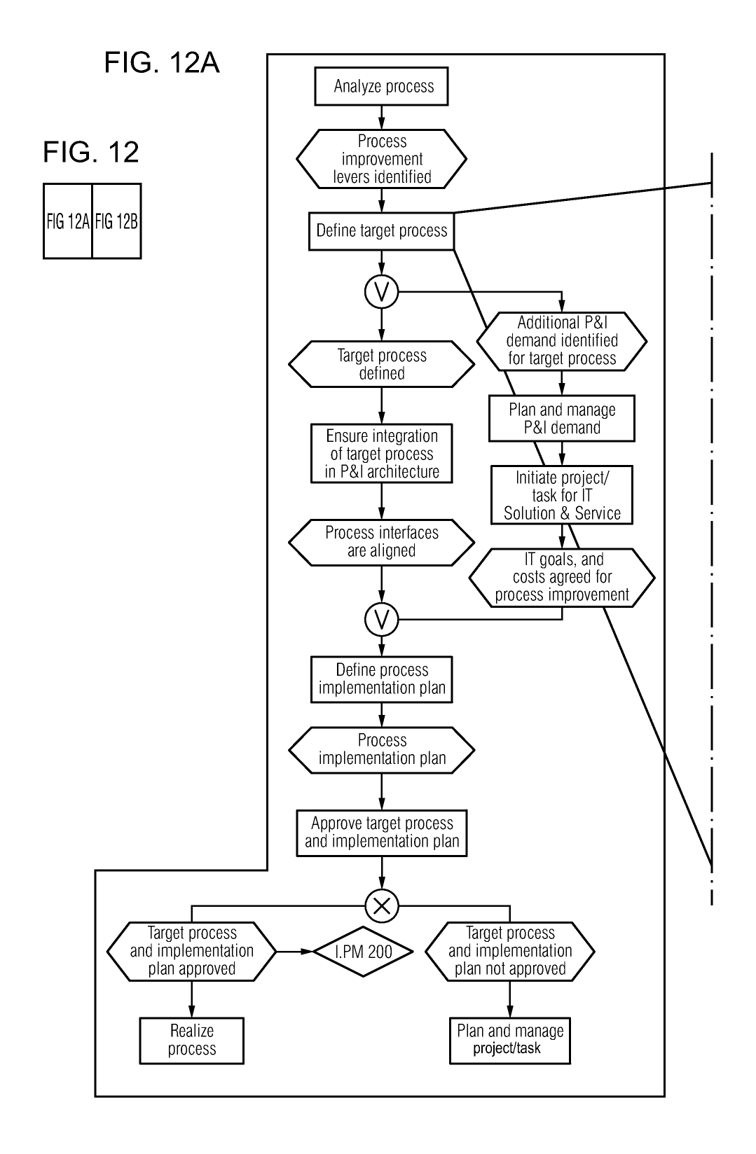

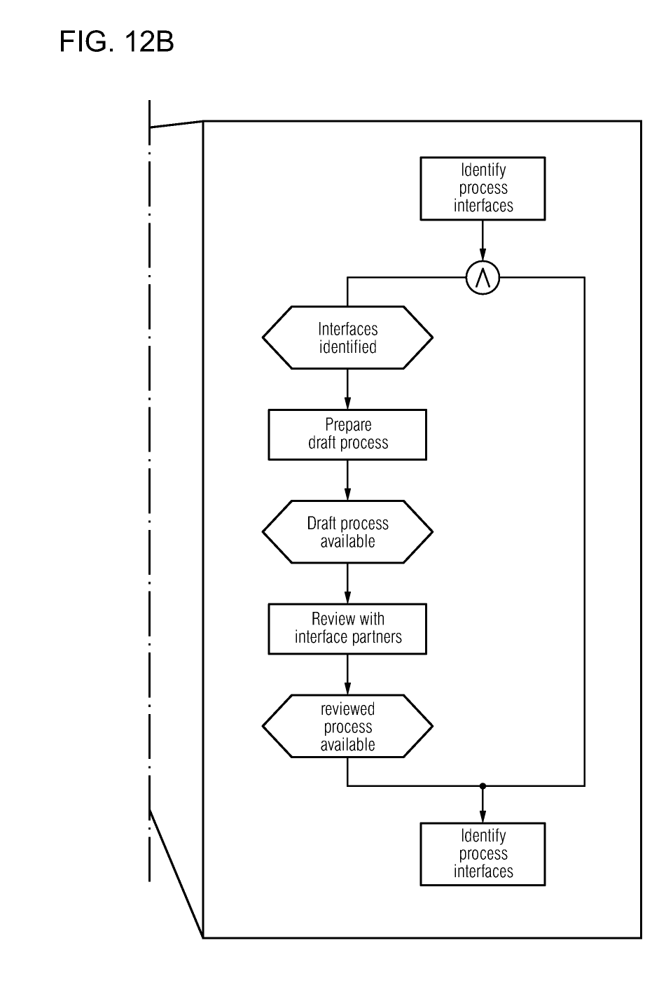

FIG. 12 shows a chronological sequence; the “Define target process” activity with its associated objects is on the left. As mentioned above, a detailed description of this activity is needed (for the purposes of this example). The user can enter a description and the result is shown on the right of FIG. 12. The right side does not appear automatically when “Define target process” is selected on the left but is created separately. How this is done is described below.

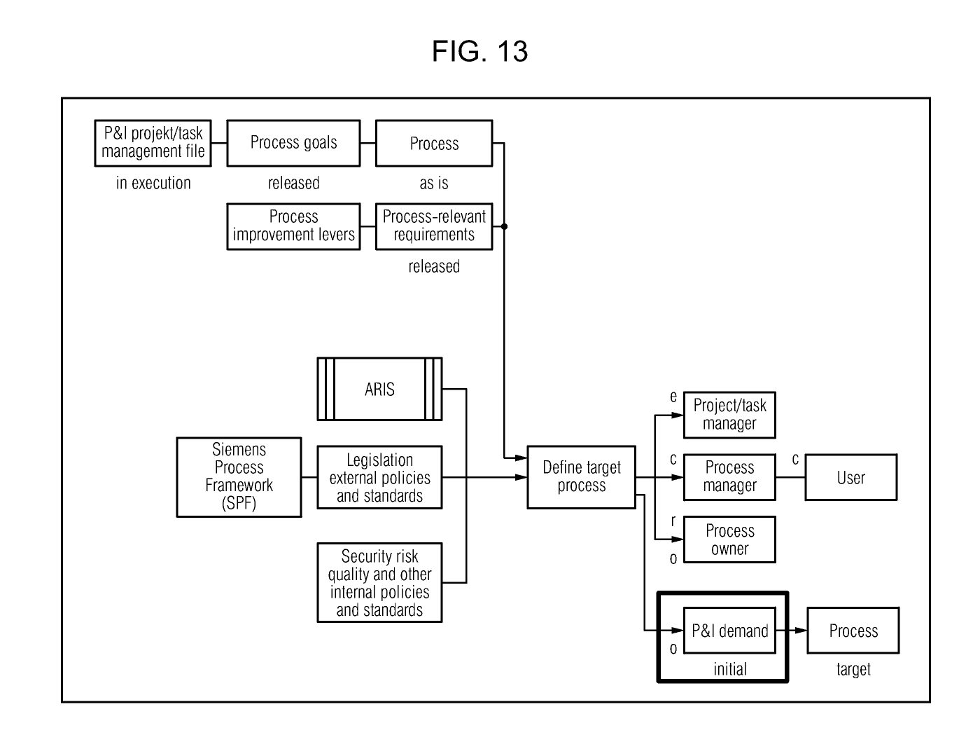

The starting point is the left half of the above FIG. 13 displayed by the tool 1. The user opens the input screen for “Define target process”.

In the screen a graphical editor can be opened to create the right side of the FIG. 12.

All icons needed to create ARIS-compatible process chains are provided in the graphical editor.

The tool 1 opens the object editor described above for each object (i.e. for each of the functions shown on the right in the above figure). The user can select or modify the attributes of the objects (e.g. the necessary inputs) in the editor.

Once the entries are complete, the tool 1 carries out several consistency checks as follows:

Completeness of the entries; i.e. have values been entered for the relevant attributes of each object created? The user is prompted by the tool 1 to enter missing values.

Basic consistency checks; e.g. linking of the activities

If the consistency checks are successful, the tool 1 closes the graphical editor and reverts to the display in the left half of the FIG. 12.

As the last sub-activity of “Adapt and detail transaction models” the metrics are defined for selected activities. It is not recommended to define metrics for all activities because the data collection effort involved (for manual collection in particular) is a critical factor.

In many cases, the creation/assignment of metrics is caused by the hierarchical breakdown of predefined indicators of higher process levels. This can be illustrated by reference to the “Hit rate” metric used in an earlier example. This metric is defined as follows:

| | |
|---|---|
| Strategic goal/ | Efficiency of acquisition |
| driver | |
| Metric | Hit rate |
| Business Unit | PSE |
| Objective | Optimize the Sell process (sell to customer |
| | product/system/services or sell project/solution) in |
| | order to save costs/resources. |
| Definition | Value of offers relative to value of signed |
| | contracts. Signed contracts (C.SP060 or PM070) |
| | are set in relation to submitted offers (X040/C.SP050 |
| | or Q.C.Pm040/PM050). Shows quality of |
| | offer process. |
| Calculation | Hit rate = (Value of Signed Contracts)/(Value of |
| | Submitted Orders) * 100 |
| Unit | % |
| Frequency | Quarterly (min), calculation period to be defined by GRO |
| Figures | Actual: 52% |
| | Target: 60% |
| Responsible | Head of GRO |
| for target | |
| achievement | |
| Responsible | BA of GRO |
| for tracking/ | |
| reporting | |

If it is assumed that GRO is subdivided into the organizational units A, B and C, the hit rate on GRO level is based on the corresponding data obtained in units A, B and C. Let us assume that only A and B of the three units is directly active in sales whereas C is an internal “supplier” for A and B. In this case, the “Hit rate” metric in organizational units A and B would be used to separately obtain the hit rate for A and B. The hit rate metric for organizational unit A is then defined as follows:

In the tool 1 the user navigates to the sub-process or function to be quantitatively captured by the metric to be defined. In our example, the user can navigate to the “Sell Process” and mark it in the tool.

The tool 1 provides a function to define metrics for marked (sub-) processes or functions. The user confirms by pressing an appropriate “button” and the tool 1 opens a new display in which all metrics are shown that are already defined for the (sub-) processes or functions, and all metrics are shown that are already defined for (sub-) processes or functions on a higher (hierarchic or logical) level. Example: The hit rate metric would be shown here because it is already defined for the Sell Process on the GRO level.

The user has now three basic options:
edit an existing metric for this (sub-) process or function
create an instance of a metric already defined for (sub-)—processes or functions on a higher (hierarchic or logical) level
define a new metric

These three basic options are described below:
To edit an existing metric for this (sub-) process or function, the user first opens the metric to be edited in the list of existing metrics.
The tool then opens a new input screen which shows all standard attributes of the metric (see table above) as input fields.
The tool 1 checks whether the metric is an instance of a metric on a higher (hierarchic or logical) level. In this case, the Metric, Definition, Calculation and Unit fields are write-protected so that they cannot be changed. This ensures that even after editing the metric is still a valid instance of the higher-level metric. All fields can be edited if the metric is not an instance of a higher-level metric.

The user can edit the fields and closes the input screen.

The tool 1 then checks that the entries are complete and saves the metric.

To create an instance of a metric already defined for (sub-) processes or functions on a higher (hierarchic or logical) level the user selects the metric for which an instance is to be created.

In the list of higher (hierarchical or logical) level metrics the user selects the metric for which an instance is to be created.

The tool 1 then makes a copy of the metric and displays it in a suitable input screen.

The Metric, Definition, Calculation and Unit fields are write-protected in the screen to ensure that the new metric is an instance of the higher-level metric.

The user edits the entries for the other fields, if necessary, and then closes the input screen.

The tool 1 then checks that the entries are complete and saves the metric.

Example:

The higher-level metric (GRO level) is defined as follows:

| | |
|---|---|
| Strategic goal/ | Efficiency of acquisition |
| driver | |
| Metric | Hit rate |
| Business Unit | PSE |
| Objective | Optimize the Sell process (sell to customer |
| | product/system/services or sell project/solution) in |
| | order to save costs/resources. |
| Definition | Value of offers relative to value of signed |
| | contracts. Signed contracts (C.SP060 or PM070) |
| | are set in relation to submitted offers (X040/C.SP050 |
| | or Q.C.Pm040/PM050). Shows quality |
| | of offer process. |
| Calculation | Hit rate = (Value of Signed Contracts)/(Value |
| | of Submitted Orders) * 100 |
| Unit | % |
| Frequency | Quarterly (min), calculation period to be defined by GRO |
| Figures | Actual: 52% |
| | Target: 60% |
| Responsible for | Head of GRO |
| target | |
| achievement | |
| Responsible for | BA of GRO |
| tracking/ | |
| reporting | |

The user selects this metric from the list of higher-level metrics. The tool 1 then opens a copy of the metric in the input screen. An example is given in the following table.

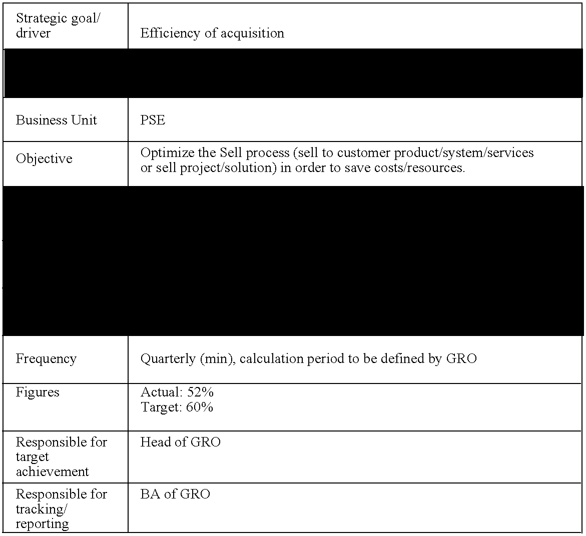

The Metric, Definition, Calculation and Unit fields are write-protected and highlighted accordingly in color. The user (the responsible line manager of business unit A, for example) now edits the values in the following fields: Figures, Responsible for target achievement, and Responsible for tracking/reporting. The result looks like this:

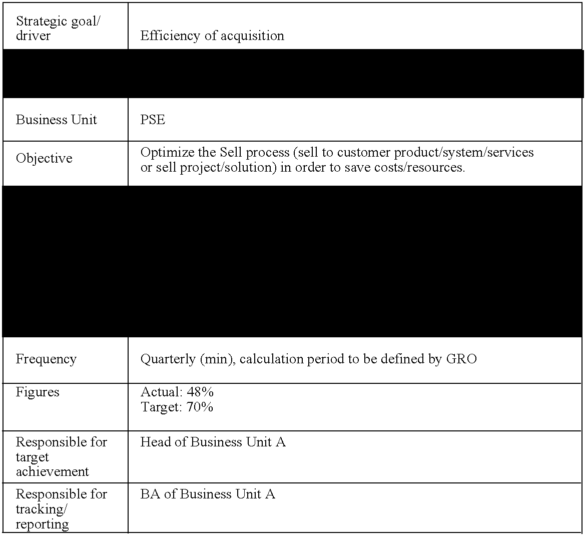

As the example shows, the fields have been modified to reflect the specific values of business unit A.

In customizing it is possible to specify for each function and each output whether the object requires an approval and, if so, of which type. Basically, there are three options:
No approval
Approval by the executing employee
Approval by a different employee (dual control principle).

In the object editor a flag can be set to indicate which type of approval is needed for each function and each output. The tool sets “No approval” by default. If an approval is required, how approval is given is specified in customizing. For example, it is possible to specify that the output is to be reviewed. This is queried by the tool if an approval flag is set accordingly.

The “Adapt & detail BTM” activity is finished once the individual steps described above have been carried out.

All the changes made in the above steps are relevant only for the selected transaction model. Changes to parent process models must be requested using the change request procedure.

In the customizing procedure described above a TM is created which “fits” the specific context i.e. a context of a specific domain transaction model and can be executed. For execution purposes, all that is missing is the assignment of resources. In line business with a large number of transaction models in cycles it is particularly important to ensure that the process flow design is very efficient and repeatable. To this end, concrete resources or resource groups can already be assigned in customizing. Resources are also assigned in the object editor described above. In the object editor the user is able to assign a concrete resource (e.g. John Smith) or a resource group (e.g. SAP application developers) to a function.

During customizing the tool 1 provides the option in each view (i.e. in the overview and in the object editor) of entering feedback on a marked object to support process improvement. To provide feedback, the user can press a “button” and the tool opens an input field where suggestions for improvement can be entered. The tool 1 saves this information together with the name and role of the user as well as a link to the marked object to which the suggestion for improvement applies.

It has already been described how the attributes of objects can be modified. In this step the inputs and outputs of functions are also defined or modified. A template is often prescribed for document-based inputs or outputs in order to ensure a certain degree of uniformity of the results in practical use. To achieve this, the tool 1 provides functionality for assigning a template to each (document-based) input/output. Template assignment is carried out in the object editor in which new inputs/outputs are also defined/modified. A direct link to a template (stored, for example, in LiveLink or SharePoint) can be added here for each document. This link enables document editing (i.e. editing of inputs and outputs) to be launched directly from within the tool. In other words, when a document is selected in an FAD, the tool automatically opens the associated template. The tool 1 functions in the same way for documented knowledge—a link to a file can also be stored here. If results are not stored in document form but in a different tool (e.g. financial data in SAP), the link can point directly to the corresponding input screen of this tool.

The term <<Execution >> in the following refers to the following steps:
Prepare Execution
Execute transaction model
Control and Monitor Execution

These three steps are first explained briefly and then described in detail in separate sections below.

A few preparations are necessary before a transaction model TM can be executed. For example, a concrete reason to execute a transaction model TM is a request from a project which executes a specific transaction model during a sub-activity. For this purpose, it is necessary to assign certain resources and dates to the transaction model. These and other preparations are part of the “Prepare Execution” phase.

The operationalization unit 1A of the tool 1 also provides various forms of support during actual execution of the transaction models TM. Based on defined transaction models TM, the tool 1 guides a user through the relevant process steps, monitors the dates in the process flow, and involves the concerned users.

The later transaction model execution can be monitored. Various aspects are taken into account; for example, monitoring of actual implementation of the individual tasks in terms of dates, and target achievement on the one hand, and monitoring of the overall use of the transaction models on the other hand. The goal of the first aspect is the successful execution of individual tasks, the goal of the second is to optimize the processes and their application.

The result of the “Adapt and detail transaction model” is a transaction model that fits the predetermined context. However, this does not mean that concrete tasks reflect the defined transaction model in every detail. For example, the transaction model can include optional activities or objects. In this case, a decision can be made as to how to deal with these activities. The “Prepare Execution” activity described in this step contains this and other preparatory planning steps. All steps described so far, i.e.:
“Define business context”
“Select relevant process paths”
“Adapt and detail transaction model”
   are carried out for the context but not for each individual task. The situation is different in the “Prepare Execution” activity as all the steps are carried out for each individual task.

“Prepare Execution” is triggered when a concrete task is to be started. In our example it is assumed that the task is part of a parent project (or sub-project). The procedure is described in two steps: a) Prepare Execution on project level, and b) Prepare Execution on task level.

A project manager can provide project requirements and develops an appropriate project plan. A first version of the project plan can show the project sequence but without specific dates and resources. The plan is created using a popular project management planning tool—the use of MS Project is assumed below. The project manager then accesses the tool 1 comprising an operationalization means and can assign a transaction model TM to each work package of the project plan. The purpose of this transaction model TM is to implement the respective work package. This step is carried out in the tool 1. In other words, the tool 1 loads the project plan and then asks step by step which transaction model TM is to be assigned to each work package. (Note: This functionality requires that the tool 1 is able to access all relevant transaction models. Consequently, the tool may not be restricted, for example, to the transaction models in the area of responsibility of a line manager but can have access to all SIS processes.)

Searching for transaction models: The search is made using the contexts and their parameters. In other words, in a possible embodiment the project manager first selects a suitable context on the basis of its context parameters. One or more transaction models TM may be assigned to the context and the project manager selects one and assigns it to the respective work package. In an alternative embodiment, the selection is performed automatically.

The tool 1 can assign transaction models TM to work packages sequentially. Earlier work packages are displayed and linked with transaction models before later packages. In each step the tool 1 checks whether all inputs required by the current activity have been generated by an earlier activity. If not, the project manager, i.e. the current user of the tool 1 is informed that there is an inconsistency. The manager now has the option of resolving the inconsistency immediately or later. The tool keeps a log of all unresolved inconsistencies. When transaction models are selected, the tool proposes typical values for duration and effort to the project manager.

If an activity in the project plan cannot be assigned to a transaction model TM, the matching context is assigned instead. This context relates unambiguously to an organizational unit and, as a result, a responsible line manager or user is defined for the context.

Once all project plan activities have been assigned either to specific transaction models or to contexts in this way, the current user can close this tool mode. The tool 1 then starts a consistency check to ensure that a transaction model TM or a context is assigned to each activity and that an output of an earlier activity is actually assigned to each input of an activity. If inconsistencies arise, the tool 1 remains in the current edit mode until the inconsistencies have been resolved by the user. Once the consistency check is completed successfully, the tool 1 closes the edit mode and sets the status of the project plan to “transaction models assigned”. The tool manages the project plans and can assign various statuses to them.

If the status of the project plan in the tool 1 is “transaction models assigned”, the tool 1 can send requests (“tickets”) to the responsible user such as a line manager. This information is present in the context and each transaction model TM is assigned to a context. These tickets can contain the following information:
Name of the requesting project and project manager
Link to the project plan and relevant work packages
Name of the requested transaction model or business mandate
Description of the required result and execution of the transaction model
Execution goals (dates, costs)
Deadline for detailed planning of the ticket

The ticket is sent to the responsible line manager or user by suitable means. The tool 1 allows the project manager to export the project plan together with empirical values for typical duration and effort for the purpose of execution of the transaction models. The user is able to select the desired export format; popular formats such as MS Project, Primavera).

Inconsistencies can arise when assigning transaction models to work packages of the project plan. These inconsistencies are handled as described below. It may be necessary to revise the assignment of transaction models to work packages for various reasons, i.e.
Changes to the project plan
Resolution of inconsistencies

These two possibilities are described separately below.

The reason for changes to a project plan can vary. If a project plan is changed this can be documented in a corresponding tool (e.g. MS Project).

The user opens the tool 1, displays the project plans assigned to him/her, and selects the changed project plan and needs to be updated in the tool 1.

The tool 1 prompts the user to load the new version of the project plan (upload functionality). The user enters the path to the new project plan version and confirms.

The tool 1 loads the new version and saves it internally. It now compares the old and the new version and identifies the differences. The differences may be as follows:
The name of the work package has changed
The sequence of the work packages has changed
New work packages have been added
Existing work packages have been removed
The start and finish dates of work packages have changed

Items a-d are of particular relevance for the assignment of transaction models. The tool 1 can now suitably display the old and the new version of the project plan and highlights the differences. It prompts the user to specify how each difference is to be dealt with. The available options are described below.

If the name of the work package has changed a new transaction model TM can be assigned or the transaction already assigned can be retained.

If the sequence of the work packages has changed the tool 1 checks whether this causes inconsistencies in the input-output relationships. If not, the tool 1 automatically accepts the change to the project plan. If there are inconsistencies, the tool 1 informs the user accordingly and logs the inconsistencies for subsequent processing.

If new work packages have been added the same procedure is adopted for the new work packages as when the project plan was first imported into the tool 1. The user selects one of the existing transaction models TM and assigns it to the work package.

If existing work packages have been removed the tool 1 checks whether removal of the work packages causes inconsistencies in the input-output relationships. If there are inconsistencies, the tool 1 informs the user accordingly and logs the inconsistencies for subsequent processing.

The reason for the resolution of inconsistencies is that changes (to the assignment of transaction models to work packages) must be made due to a change to the project plan or due to the incorrect assignment of transaction models TMs.

The tool 1 can work through the list of inconsistencies sequentially starting with the earliest inconsistencies in the process. The tool 1 displays the relevant facts for each inconsistency (e.g. a transaction model expects input that is not generated by any of the preceding transaction models) and can prompt the user. The tool 1 automatically offers any possible solutions it finds to the user. Example: If an input of a transaction model is missing (i.e. has not yet been generated in the project plan), the tool searches for transaction models that generate the appropriate output and offers this output to the user for selection.

This concludes the first step (“Prepare Execution on project level”). The next step is “Prepare Execution on task level”. In project scenarios the two steps built on each other as b) cannot start until a) has finished and project execution can only begin once b) has completed successfully. However, in line business “Prepare Execution on project level” can be omitted and an immediate start can be made with “Prepare Execution on task level”. The description below is seen from the viewpoint of a line manager as a user who receives a ticket sent by the tool 1—as described above.

The differences that occur when genuine line business only is involved (no embedding in a project context) are also described below.

To prepare an execution on task level various scenarios can be differentiated as below:
The ticket relates to a concrete transaction model
The ticket does not relate to a concrete transaction model but to a context
The line manager or user rejects the ticket

If the ticket relates to a concrete transaction model TM and the line manager has received the ticket by email, he acknowledged its contents, and agrees that execution is within his/her area of responsibility. This agreement is not mapped in the tool 1 but is assumed implicitly. Ticket rejection is dealt with separately below. The line manager checks the contents of the ticket and compares them with resource planning in his/her area of responsibility. For this purpose, the tool 1 provides support in the form of empirical values; i.e. the tool 1 displays metrics or empirical values for the duration, effort of execution for the appropriate transaction model. (Further information is provided below.) The result of this step is a statement on the feasibility of the task in view of the targets specified in the ticket. If the targets cannot be achieved, the line manager and project manager discuss the matter and, if necessary, the project manager initiates generation and dispatch of a new ticket with (modified) target values by the tool 1. In the following it is assumed that the line manager considers the ticket targets to be feasible.

The line manager can generate the transaction model TM in the tool 1. A new “task” is created in the tool 1 for this purpose. A task is an independent object which can comprise the following parameters:
Task ID
Ticket ID (only if embedded in a project)
Name
Link to work package (only if embedded in a project)
Resource or resource group
Start date
Finish date
Reference transaction model
Modified transaction model

(The individual parameters are discussed below.) By default, the tool 1 can create a task based on a project plan available in the tool; i.e. the task is linked with an activity in the project plan. However, the tool 1 also enables a task to be created without reference to a project plan.

The tool 1 prompts for the ticket ID as key input. The line manager can be shown a list of the tickets currently open for this purpose. The line manager then selects the relevant ticket and the tool opens a screen for further editing of the newly created task.

The tool 1 then automatically supplies the following parameters with values:
Task ID
Ticket ID
Name (=name as the assigned project plan activity)
Link to the project plan activity
Finish date
Reference transaction model

The “Resource”, “Start date” and “Modified transaction model” parameters are not supplied with values by the tool. Also, the user is able to change the value of the “Name” parameter. The values of the other parameters cannot be changed. If, for example, the line manager does not agree with the finish date, this can be clarified as described above.

The line manager checks the value of the “Name” parameter and changes it if necessary. The required resource is then assigned to the task. To do this, the line manager can assign a specific employee and a Prepare Execution deadline to the task before saving the task.

The tool 1 checks that the requisite data is complete and sends an email to the employee to whom the task has been assigned either by the line manager or by a ticket system (task supervisor). The email contains a link to the task (in the tool). The employee can then open the task in the tool (via the link) and checks the task description. The employee then creates the “Modified transaction model” in the next step as follows:

The tool 1 asks if a copy of the reference transaction model is to be created or whether a previously modified transaction model is to be used as a template. The relevant transaction models are displayed in a list for selection. The tool switches to edit mode so that the selected transaction model can be edited. At the same time, the tool 1 creates a dedicated storage area for the task in the document management system (e.g. Sharepoint) and stores a copy of all the templates linked with the transaction model in this area. From here onward, the input and output links do not point to the general templates but to the results of this task.

The tool 1 informs the employee as a user of all activities or objects of the transaction model that are optional or can be modified and prompts for a decision on how to proceed (this is referred to as the “tailoring decision” below). For this purpose, the tool focuses successively on all optional activities/objects by optically highlighting them in the process representation. At the same time, an input screen is opened for the highlighted activity (or object). The screen prompts for a decision on whether the activity is to be executed (or whether the object is to be applied). This is illustrated for our example in FIG. 13. The “P&I demand” output is optional and the tool informs the user accordingly, e.g. by means of optical highlighting. The tool 1 prompts for brief documentation of the reasons for all tailoring decisions made in this way. The user can explain the reason for his/her decision. In our example, the reason can be as follows: “P&I demand not relevant because already available.”

In this way the tool 1 prompts for a user decision and the associated reason for all optional activities. This information is recorded by the tool and the resulting tailoring log is saved (in the tool) as a separate document so that it can be viewed at any time later.

Several options can now be provided depending on the specific usage scenario. If possible, the line manager reviews the tailoring log created by the user. The particular purpose of this review is to ensure that the tailoring decisions are sufficiently justified and understandable. If the line manager does not agree with the tailoring decisions of the employee, they can review the decisions in an attempt to reach mutual agreement. The purpose of this step is to take sufficient account of the task targets and the process requirements. As a result of the discussions, tailoring decisions can be modified or revised if necessary; the employee documents the discussion results in the tool 1. The final tailoring log is released by the employee and the line manager. Release of the tailoring log can also be documented by the tool. A different approach is adopted for high-volume daily operations. In this case, the tailoring log is created once only, is checked by the line manager, and then acts as the basis for all subsequent instantiations of the transaction models. In exceptional situations, line management may also decide to omit this step. When the tailoring log is released, the tool 1 generates the concrete process for the task from the transaction model TM. This task process is the mandatory process description for the specific task and is saved by the tool in the “Modified process” parameter.

All transaction models TMs are edited by the relevant employees and agreed with the line manager in this way. The tool 1 sends a notification to the project manager when the tailoring log is released. The project plan maintained in the tool 1 is also updated when the log is released. The tool 1 sets the status of the assigned project plan activity to “Task assigned” for each task released by the employee and the line manager. Once all project plan activities have the “Task assigned” status, the status of the overall project plan is set to “Task assigned”. It is therefore always clear to all participants and, above all, to the project manager when the overall project plan (of parts thereof) has been sufficiently planned to enable execution to be started.

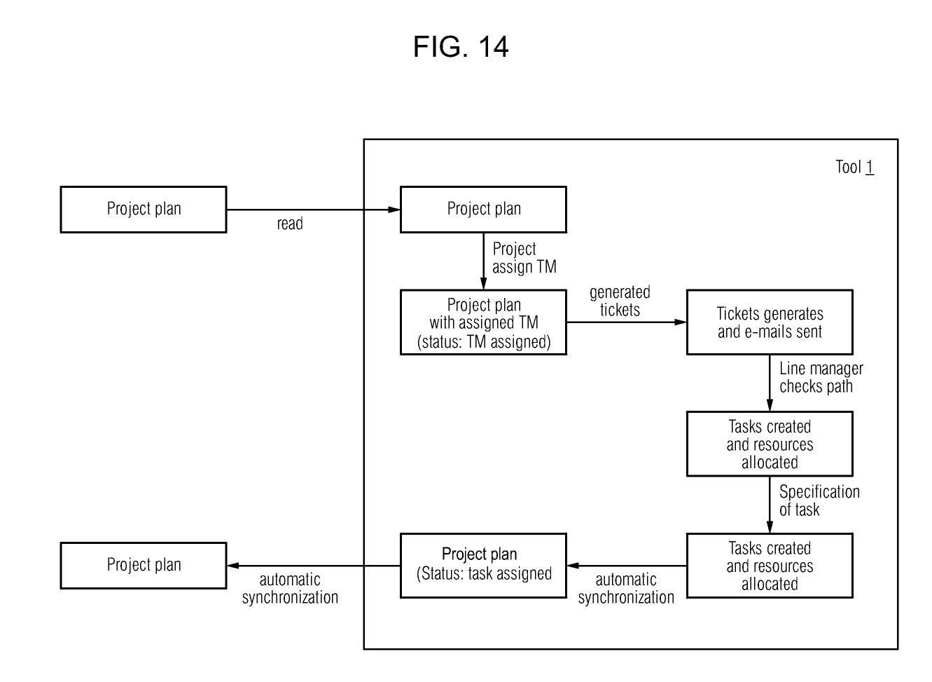

The relationships between project plan, transaction model TM, ticket and task are illustrated in FIG. 14.

The situation that a ticket does not relate to a concrete transaction model but to a context can be expected if the project manager cannot find a suitable transaction model but assumes that the activity can be meaningfully assigned to a specific context.

In this case the procedure is as follows:

The line manager has received the ticket by email, has acknowledged its contents, and agrees that execution is within his/her area of responsibility. This agreement is not mapped in the tool 1 but is assumed implicitly. Ticket rejection is dealt with separately.

When carrying out the check, the line manager determines that a context and not a transaction model is assigned to the ticket. Based on the activity description in the ticket, the line manager first checks whether there is a transaction model that matches this description. If so, the manager assigns this transaction model to the ticket and continues as described in the last section above. If not, the following procedure is adopted:

The line manager opens the tool 1 and creates a new transaction model. For this purpose, the tool opens a dedicated screen for the creation of new transaction models. In the first step the line manager specifies to which context the newly created transaction model is to be assigned.

Once the transaction model TM has been created, the same procedure as described above is adopted, in other words, the line manager assigns a resource to the BTM and the tool starts further processing.

Below we turn to the third of the three possible scenarios mentioned above.

The situation that the line manager rejects the ticket occurs only if the line manager is convinced—on the basis of the ticket description—that his/her area of responsibility is not involved. This can be justified if the ticket does not match any context or domain for which the line manager is responsible.

In practice, it is necessary to rely on the judgment of the line manager and project manager to reach an appropriate decision. A concrete task description (included in a ticket) may, in the view of the project manager, have similarities with the description of a specific transaction model TM. However, in the specialist view of the line manager, it may be clear that the transaction model does not match the task.

If the project manager and line manager cannot agree, the matter is escalated to the next level up in the hierarchy.

The procedures described above assume that only one employee is charged with task execution. However, it may be necessary for a team of employees to implement more complex tasks. In this case, the employee to whom the line manager assigns a specific task acts as the task manager and the team coordinator. The other team members are also entered in the tool and assigned to the task. This is the job of the line manager who typically does this in parallel to task planning by the task manager. However, there is an alternative scenario in which all employees associated with a task assign themselves to the task—with the support, for example, of a corresponding ticket system. This scenario is encountered above all in line business with high throughput.

This concludes the “Prepare Execution” activity with the following result: A transaction model TM and a task are assigned to all activities of the project plan and the status of the project plan is therefore “Tasks assigned”.

The line manager has created a task for all activities assigned to him/her by the project manager. A concrete resource is assigned to the task which has been fully planned.

The “Modified transaction models” have been created and assigned for all tasks. New transaction models may also have been created in this step.

Further above a situation is mentioned in which a task can be started independently without being embedded in a project—this is the typical situation in purely line business. In this case, transaction model processing is not started by means of tickets but directly by line management or by other events. The procedure is then as follows:

A task is created in the tool 1. This can be done manually (line manager acts as user) or can be triggered by a ticket system. As stated above, a task is an independent object which can comprise the following parameters:
Task ID
Ticket ID (only if embedded in a project)
Name
Link to work package (only if embedded in a project)
Resource or resource group
Start date
Finish date
Reference BTM
Modified BTM

The tool 1 automatically supplies the following parameters with values:
Task ID
Ticket ID
Name (=name as the assigned project plan activity)
Link to the project plan activity
Finish date
Reference transaction model

The “Resource”, “Start date” and “Modified transaction model” parameters are not supplied with values by the tool. Also, the user is able to change the value of the “Name” parameter. The values of the other parameters cannot be changed. (If, for example, the line manager does not agree with the finish date, this should be clarified as described above.)

Manual task processing: The line manager checks the value of the “Name” parameter and changes it if necessary. The required resources are then assigned to the task. To do this, the line manager assigns a specific employee and a Prepare Execution deadline to the task before saving the task. When resources are assigned using a ticket system, no manual processing by the line manager is involved.

The tool 1 checks that the requisite data is complete and sends an email to the employee to whom the task has been assigned either by the line manager or by a ticket system (task supervisor). The email can contain a link to the task (in the tool).

The employee opens the task in the tool 1 (via the link) and checks the task description. The employee then creates the “Modified transaction model” in the next step as follows:

The tool creates a copy of the reference transaction model. This is the initial value for the “Modified transaction model” parameter. The tool 1 switches to edit mode so that the selected transaction model TM can be edited. At the same time, the tool can create a dedicated storage area for the task in the document management system (e.g. Sharepoint) and stores a copy of all the templates linked with the transaction model TM in this area. From here onward, the input and output links do not point to the general templates but to the results of this task.

The tool 1 informs the employee as a user of all activities or objects of the transaction model TM that are optional or can be modified and prompts for a decision on how to proceed (this is referred to as the “tailoring decision” below). For this purpose, the tool 1 focuses successively on all optional activities/objects by optically highlighting them in the process representation. At the same time, an input screen is opened for the highlighted activity (or object). The screen prompts for a decision on whether the activity is to be executed (or whether the object is to be applied). This is illustrated for our example in the above figure. The “P&I demand” output is optional and the tool informs the user accordingly, e.g. by means of optical highlighting.

As in customizing, during “Prepare Execution” the tool can provide the option in each view (i.e. in the overview and in the object editor) of entering feedback on a marked object to support process improvement. To provide feedback, the user presses a “button” and the tool opens an input field where suggestions for improvement can be entered. The tool saves this information together with the name and role of the user as well as a link to the marked object to which the suggestion for improvement applies.

The step of executing a transaction model TM begins with implementation of the tasks by the assigned employees. The tool 1 provides various forms of support in this step.

Once the processing of functions or outputs has been completed, the tool 1 checks by default which type of approval is needed. If an approval is needed, two situations can occur. The current employee is prompted to carry out approval, or a different employee is prompted to carry out approval. The tool 1 starts the approval step in both cases and informs those involved that approval is needed. Approval itself calls for a user activity that has been defined in customizing (see above) and must be performed by the user as part of “Execute transaction model”. The tool 1 prompts for confirmation and, if necessary, a description of the activities performed for approval purposes. If approval is not successful, the tool 1 informs the employees involved and the relevant line management.

If the modified transaction model TM contains an OR branch after completion of a function, the tool 1 prompts the user (task supervisor) to specify which path is to be followed. The user is prompted to enter a reason for his/her decision. The tool 1 archives the decision in the modified transaction model. In customizing it is possible to specify whether the tool 1 is to prompt for a reason (default setting) or may continue without entry of a reason.

Each day the tool 1 can check the start dates of all tasks whose status is “fully planned”. If the start date is less than a week in the future, the tool 1 can send a work schedule covering the first week of the task to the responsible employee (i.e. the task supervisor, referred to simply as the “employee” below). The work schedule shows all activities due in the first week of task implementation in detail and the activities due in subsequent weeks in overview form. The corresponding table can look, for example like this:

| Activity | Start date | Finish date | Result | Participants: | Status |
|---|---|---|---|---|---|
| Prepare | 1.9.2008 | 2.9.2008 | Draft | | In |
| Draft | | | Process | | process |
| Process | | | | | |
| Review | 2.9.2008 | 3.9.2008 | Reviewed | Interface | Fully |
| with | | | Process | Partners | planned |
| Interface | | | | | |
| Partners | | | | | |
| Internal | 3.9.2008 | 5.9.2008 | Released | Internal | Fully |
| Review | | | Process | Stakeholders | planned |

If the employee works on more than one task in parallel, the tool 1 is able to show the activities of all relevant tasks arranged chronologically or according to tasks. If weekly display of the pending activities is not appropriate, the employee can change the display to, for example, daily or monthly.

The list of current and pending activities also shows the status of the activities. The status of some of the activities is set automatically by the tool 1. The employee can change the status to “In process” and “Completed” manually in the tool. The tool logs the times of all status changes in order to calculate typical durations. If more than one employee is involved in a function (e.g. responsible employee with the “e role” and further employees with the “c role”), the tool 1 prompts all employees to confirm the “Completed” status.

The tool 1 regularly prompts the employee or user to enter the current status if the time since the last update exceeds a defined period (e.g. is longer than a week ago). In the case of activities scheduled to last longer than a week, the tool 1 prompts the employee to enter the estimated work progress (in terms of effort). Work progress can be entered as a percentage value. For example, 50% would mean that the employee assumes the total remaining work would require the same effort as the work already completed. In parallel, the tool 1 prompts the user to enter the estimated completion date. The tool 1 is only able to calculate a theoretic completion date using the effort-based work progress value. There is usually a difference when the completion date estimated by the user and the date calculated by the tool 1 are compared. The tool 1 escalates to line management if the difference exceeds a threshold (that can be defined in customizing). The tool also escalates to line management if the completion date estimated by the employee or the date calculated by the tool exceeds the scheduled completion date by a given period of time (that can also be defined in customizing). The tool 1 also can offer users the option of direct escalation—in the event of delays, for example.

All status monitoring parameters (e.g. how often the tool prompts employees for the status) can be changed. These changes are made in customizing.

Based on date and status information (including work progress information) the tool 1 can generate regular (e.g. weekly) status reports that are sent to users such as employees, line manager and the project manager. The status report for employees shows only the activities relevant to the employee who receives the report. The status report for line management shows all activities where there is an increased risk of delay (or costs overrun) in a suitable way (e.g. traffic light display).

All data collection cycles and status report generation cycles can be configured.

If the “inform after execute” attribute is set for a participating role, the employee assigned to the role is informed accordingly.

Previously, tool support is described for the responsible employee. However, many functions involve cooperation between various roles. The tool 1 enables those involved with a function to be informed (by email, for example) that function execution is pending and their participation is required. The tool does can do this at the request of the employee responsible for the task. However, in customizing it is possible to specify whether this is done manually or automatically. For this purpose, the tool 1 provides an option so that it is possible to decide separately for each function whether the participants are to be informed or not. If notification of the participants has been selected, the tool 1 can send emails with a brief summary of the relevant data and with links to the associated tasks in the tool 1.

Project execution can largely be supported by other tools (e.g. MS Project, Primavera or Opal, SAPPORO, OSD). The monitoring of dates and budgets can also carried out in part by other tools.

“Control and Monitor Execution” has several goals and this fact can be well illustrated from the different viewpoints of the various tool users. (Sub-) project managers and line managers need transparency with regard to planning status and work progress in a suitably summarized display of all relevant tasks.

Employees need an overview of the task status and of the assigned transaction models and functions that are relevant to them.

The line manager and the project manager need continuous and reliable empirical data for use in planning. Empirical data may relate, for example, to the typical duration of a task.

The line manager needs various overviews or evaluations for purposes of process optimization.

In particular, process performance measurements as a basis for process cost calculation and optimization.

The primary focus of the first three items above is operational execution; i.e. the status of planning and execution of the specific tasks or planning steps is considered. The focus of the final item is different and relates to medium- and long-term improvement of the processes (i.e. transaction models). In customizing—also of “Prepare Execution”—process paths are selected from the generic processes and are supplemented or specified in more detail. The changes to the generic processes are a source of valuable information for process management. For example: if certain activities are almost always omitted (e.g. in customizing), this is an indication that, for example, the activities perhaps do not sufficiently meet real-world requirements. This is where targeted process improvement can start.

The various aspects of “Control and Monitor Execution” are described separately below, firstly with respect to support for controlling planning and work progress.

From the viewpoint of a project manager or a sub-project manager the tool continuously tracks all deadlines set by the (sub-) project manager for ticket processing. It provides suitable overviews so that due and overdue tickets can be recognized simply and quickly. As an option the (sub-) project manager can have the tool notify him/her automatically when the status of a project plan element changes. This can be the case, for example, when a task has been fully planned and its status changes from “BTM assigned” to “Task assigned”.

From the viewpoint of a user such as a line manager the tool 1 can continuously check the deadlines of all tickets assigned to a line manager. It provides suitable overviews for all relevant tickets and their status. The status of a ticket can be either:
Open if no task is assigned.
In process if a task is assigned but the “Prepare Execution” activity has not been completed (e.g. because the “Modified transaction model” has not yet been created).
Closed because a task is assigned and the “Prepare Execution” activity for the ticket has been completed; in other words, the tailoring log for the task has been released.

The tool 1 also provides the option of sending “Reminder emails” to draw attention to pending deadlines and to overdue tickets; this functionality is user-configurable, e.g. users are able to set the cycles/times in and at which reminder emails are sent.

The tool 1 can continuously track all deadlines set by the line manager for the processing of a specific task or planning job.

Here, planning job means all steps that must be carried out by the responsible employee between task creation and full task planning.

“Task” refers to the execution of a task that has been fully planned.

The tool 1 sends a reminder to the responsible employee at appropriate intervals. If the deadline has passed and the employee has not processed the task, the tool 1 informs the line manager accordingly by email.

The line manager can have the status of tasks suitably displayed by the tool 1 at any time. All tickets and tasks are shown together with their status in an overview.

The status of a ticket indicates the progress of the planning activities. By contrast, the status of a task shows the progress of execution. The following statuses can be available:
Created if the task has been created (and is therefore automatically assigned to a ticket).
Assigned if the task has been assigned to a specific resource.
Fully planned if the tailoring log for the task has been released.
In process if implementation has started but is not yet finished.
Completed if implementation has finished.

The ticket statuses are set fully automatically by the tool 1. All task statuses are managed by the tool but some are set manually by the user (In process, Completed).

From the viewpoint of process optimization (process management, line management) the primary goal is medium- and long-term process optimization.

For this purpose, the tool 1 can track all customizing and modification activities so that evaluations can be made. This is illustrated below by reference to an example of the P&I process.
Information on the total number of times the P&I process has been customized.
A percentage value is specified for each sub-process of the P&I process to indicate the percentage of cases in which an activity has been retained or omitted in customizing.
A percentage value is specified to indicate the percentage of cases in which each activity or object on the more detailed level of process display has been retained in customizing/tailoring.
The information on the detailed level can be aggregated into a total percentage by the tool. This figure is an indication of how many of the objects (in a process, for example) have been customized and to what extent.

Example for the “Define Process” sub-process:

| | Value of the |
|---|---|
| Name of the parameter | parameter |
| Customizing quota (item 2) | 90% |
| Define target process | 100% |
| Ensure integration of target process in P&I architecture | 50% |
| Define process implementation plan | 80% |
| Approve target process implementation plan | 70% |

From this (fictitious) example it is evident that the “Define Process” sub-process is retained in 90% and omitted in only 10% of the cases in customizing. It is also apparent that the “Ensure integration of target processes in P&I architecture” activity is retained in only half of the cases in customizing. This is a clear indication that users see problems in practical implementation.

Each line can be selected directly in the overview. The detailed information that has been summarized into a percentage value is then displayed. If, for example, the “Ensure integration of target process in P&I architecture” entry is selected in the above table, the tool 1 opens a separate list in which all cases in which this activity has been deselected are indicated separately. All entries in the list are also linked to the associated detailed information.

This type of evaluation gives a clear indication of which activities are heavily used in practice and which are often omitted in customizing. Attention can be placed on the latter in a (yearly) revision of the processes.

The evaluations described above act as input for the controlling of customizing. A further controlling focus is the modification of BTMs that takes place during the “Prepare Execution” activity. The tool 1 can provide similar functions for this purpose.

A record is kept of the number of attributes of each activity or object in the P&I process that were modified in “Prepare Execution”. The tool can aggregate this data to a percentage value that reflects the modifications on the object attributes level. List display and linking with the associated detailed information are as described above.

A record can be kept of the number of attributes of each element (activity, sub-process, object) in the P&I process that were added on lower levels of detail in “Prepare Execution”. These evaluations are also summarized as a percentage value that is linked with the detailed information.

The evaluation provide information on the sub-processes in which the granularity is appropriate and on the sub-processes where there is a need for further detailing.

From the collection and use of empirical values empirical values are required for the planning of tasks and projects. These are primarily the duration, effort and costs of execution. Other data may also be relevant from case to case. The tool provides support by continuously tracking task processing and logging the corresponding data.

The base data used when processing tasks is assigned to the transaction model on which the task is based.

The tool 1 can determine such base data as follows:

For each task the tool 1 can monitor how long the task remains
in the “assigned” status (planning duration), and
in the “in process” status (execution duration).

These two values indicate how long it took to plan and execute a concrete task. The tool 1 tracks these two values for each task and allocates the values to the transaction model to which the task is assigned. The values can be suitably aggregated in the transaction model in order to calculate the following:
Average value
Minimum value
Maximum value
Standard deviation

On the basis of these empirical values, the line manager or employee is able to estimate how much time will be needed to carry out a pending task. If there are particular complications due, for example, to the requirements involved, a value above the average can typically be expected. On the other hand, a duration greater than the previous maximum should not be expected. If this happens, the underlying reason should be investigated.

An optional setting can be made in the tool 1 to inform the line manager automatically if certain thresholds are exceeded when a task is planned. The setting can be configured so that an email is always sent to the relevant line manager if planning deviates from the average value by more than the standard deviation.

The tool 1 can track an effort involved in the planning and processing of each task. For this purpose, the tool can be linked to the accounting system so that e.g. working hours posted can be regularly assigned to a task in the system. The associated entry in the accounting system is generated and linked automatically when a task is created. In other words, there is an entry in the accounting system for each task created in the tool.

Only the summarized effort is tracked and no distinction is made between the effort for task planning activities and for actual task execution.

Even if several employees work on a task, the effort is summarized for all employees and is not recorded separately for each employee.

The tool 1 records the effort for each task and posts the effort to the associated transaction model. The data collected in this way is used to calculate and store the following: duration, average value, minimum value, maximum value, and standard deviation.

The task execution costs are made up of several items including the following:
Costs for work performed
Costs for materials used
Costs for sub-contracted work
etc.

This list is for illustration purposes only and must be replaced with the appropriate cost structure of the relevant commercial unit when tasks are implemented. All costs are linked with the associated task and the tool regularly compares them with those available in the commercial IT system. The systems must be suitably interconnected for this purpose.

The costs per task can be determined in this way and are assigned to the associated transaction model. The data collected in this way is used to calculate and store the following: duration, average value, minimum value, maximum value, and standard deviation.

In the planning phase the empirical values are automatically displayed to line management and to employees so that they can be used directly.

1. A method for transforming generic processes of a domain into executable processes, the method which comprises the steps of:
selecting from a list of generic processes stored in a process repository at least one generic process for a context of the respective domain;
performing an operationalization of process elements of said selected processes to generate a corresponding transaction model depending on said context; and
instantiating said transaction model on occurrence of a transaction trigger to generate an executable transaction model instance.

2. The method according to claim 1, which comprises executing the transaction model instance with a process execution engine.

3. The method according to claim 1,
wherein said context indicates constraints for an operative unit comprising mandatory context parameters and
optional context parameters.

4. The method according to claim 1, which comprises selecting a context from a predefined context stored in a context repository.

5. The method according to claim 1, wherein said transaction model is a business transaction model forming a target process to be implemented.

6. The method according to claim 1, wherein a process element comprises attributes which are adapted to operationalize the respective process element.

7. The method according to claim 6, which comprises performing a consistency check of the modified process elements.

8. The method according to claim 6, wherein the attributes of a process element comprise:
inputs,
outputs,
roles,
persons,
documentation,
milestones,
applications,
risks,
metrics,
services, and
operative units.

9. The method according to claim 3, comprising:
clients,
products,
services,
organizations,
locations,
complexities of applications, and
interfaces to other processes.

10. A tool for transformation of a process comprising a program for performing the followings steps:
selecting from a list of generic processes stored in a process repository at least one generic process for a context of the respective domain;
performing an operationalization of process elements of said selected processes to generate a corresponding transaction model depending on said context; and
instantiating said transaction model on occurrence of a transaction trigger to generate an executable transaction model instance.

11. The tool according to claim 10, wherein the transaction model instance generated by the tool is executed by a process execution engine.

12. The tool according to claim 10, wherein said tool is a software tool stored on a data carrier.

13. An apparatus for transformation of a selected process model comprising:
an operationalization unit which performs a operationalization of process elements of the selected process model to generate a transaction model depending on a stored context indicating constraints of an operative unit; and
an instantiation unit which performs an instantiation of said transaction model on occurrence of a transaction trigger to generate an executable transaction model instance.

14. The apparatus according to claim 13, wherein each process element comprises attributes which are adaptable to operationalize the respective process element, said attributes comprising:
inputs,
outputs,
roles,
persons,
documentation,
mile stones,
applications,
risks,
metrics,
services, and
attributes of operative units.

15. The apparatus according to claim 13, wherein the context is stored in a context repository comprising mandatory and optional context parameters.

16. The apparatus according to claim 15, wherein said context parameters comprise
clients,
products,
services,
organizations,
locations,
complexities of applications, and
interfaces to other processes.

17. The apparatus according to claim 13, wherein said transaction model instance is executable by a process execution engine connected to said apparatus.

18. An apparatus for transformation of a process, comprising:
means for selecting from a list of generic processes stored in a process repository at least one generic process for a context of a domain,
means for performing an operationalization of process elements of said selected processes to generate a corresponding transaction model depending on said context, and
means for instantiating said transaction model on occurrence of a transaction trigger to generate an executable transaction model instance.
